(19) United States
(12) Patent Application Publication
(10) Pub. No.: US 2026/0228880 A1
(43) Pub. Date: Aug. 6, 2026

(54) Automated Tubular Running System with Integrated Thread and Pipe Inspection Using Imaging

(71) Applicant: Weatherford Technology Holdings, LLC, Houston, TX (US)

(72) Inventors: Benjamin Sachtleben, Hannover (DE); Lizabeth J. Ly, Katy, TX (US); David Geissler, Hannover (DE); Mohammed Zafaruddin, Langenhagen (DE)

(21) Appl. No.: 19/049,343

(22) Filed: Feb. 10, 2025

Related U.S. Application Data
(60) Provisional application No. 63/753,538, filed on Feb. 4, 2025.

(51) Int. Cl. G06T 7/00

(52) U.S. Cl. CPC G06T 7/0008; G06T 2207/20081

(57) ABSTRACT

In running tubulars, threaded tubular connections are made up by applying torque in rotating one tubular in turns with connection equipment relative to another tubular. Equipment sensors measure data during the make-upmake-up of the threaded connections, and a computer system processes the data to generate graphical representations of the processed data. The system receives user-indicated assessments of the threaded connections indicating whether a connection error of a failed make-upmake-up has occurred. An artificial intelligence model implemented on the system is trained with the graphical representations based on the user-indicated assessments. In subsequent connections, the trained model analyzes the graphical representations for the connection error and provides outputs accepting and rejecting the threaded connections.

### CROSS-REFERENCE TO RELATED APPLICATIONS

This application claims the benefit of U.S. Provisional Appl. 63/753,538 filed Feb. 4, 2025, which is incorporated herein by reference in its entirety.

### BACKGROUND OF THE DISCLOSURE

Long tubular strings are used for casing, risers, drillstring, completion strings, or other tubing strings in oil or gas wells. Due to their length, these strings are made up of sections or stands of tubulars that are progressively added to or removed from the tubular strings as the tubular string are lowered or raised from a drilling platform.

To construct the tubular strings, tubulars are connected by fluid-tight threaded joints, which have a connection threaded together to a target torque. A tong assembly is commonly used to make up or break out the joints between the tubulars in the tubular string. During make-up the joint between tubulars, the tong assembly holds one tubular stationery and rotates the other tubular until a target torque is reached for the threaded connection.

Several approaches are used to make up the joint to a target torque. For example, an operator can manually control the tong assembly. During make-upmake-up, the tong assembly rotates one tubular of the joint, while the other tubular is held stationery. A dump valve is then used to stop the rotation when a target torque is reached. Depending on parameters of the tubulars, this manual control may lead to over torque of the threaded connection, when the rotational speed of the tong assembly is too high at a final stage of making up the joint.

In another approach, the tong assembly can use a closed-loop control of torque or rotational speed during make-up to achieve the target torque. Depending on the set speed, the closed-loop control may take a long time to make up each joint. As an alternative, the control of the tong assembly can rotate the tubular for a predetermined time at a constant speed to achieve the target torque. The predetermined time is obtained from heuristically measured values, which are results of particular parameters, such as the reactions time of the tong assembly to a specific type of tubulars and the speed of the tong assembly.

After the joint is made up, the threaded connection is typically evaluated before carrying any loads and being run into the well. Current systems rely on predefined algorithms to evaluate the quality of threaded connections. For example, to accept or reject a threaded connection, these predefined algorithms make manual or semi-automated assessments of torque, turn, and time data obtained during make-up of the threaded connection. Unfortunately, the initial evaluation based on these measurements can diagnose false connection failures. Therefore, a human operator has to perform further examination to reach a final decision whether to accept or reject the threaded connection. Therefore, there is a need for improved methods for making up and evaluating threaded connections of tubulars.

Prior art in the field of tubular running systems commonly involves manual inspection of threads and pipes, both before and after connections are made. This includes visual inspections by personnel to check for damages, proper application of lubricant (dope), and verification of thread types. There are some automated systems that perform inspections post-failure to determine causes of leaks or other issues. However, there is a lack of systems that incorporate continuous and comprehensive pre-connection inspections using imaging technology, which can document and analyze conditions to prevent failures.

The subject matter of the present disclosure is directed to overcoming, or at least reducing the effects of, one or more of the problems set forth above.

### SUMMARY OF THE DISCLOSURE

A method disclosed herein is used in running tubulars on a rig. The method comprises: initiating a make-up of a threaded connection between the tubulars using connection equipment on the rig; obtaining at least one visual representation associated with the threaded connection; analyzing, in an analysis with an artificial intelligence model implemented in a computing environment, the at least one visual representation for at least one connection error associated with the threaded connection; and providing, with an output interface in the computing environment, a result for the threaded connection based on the analysis.

In the method, analyzing, in the analysis with the artificial intelligence model, the at least one visual representation for the at least one connection error associated with the threaded connection can comprise: detecting at least one condition associated with the threaded connection captured in the at least one visual representation; evaluating, in an evaluation, the at least one detected condition with respect to at least one specification; and determining, in a determination based on the evaluation, that the at least one condition of the threaded connection is indicative of the at least one connection error. Providing the result for the threaded connection based on the analysis can thereby comprise providing a rejection of the threaded connection based on the determination.

For example, the at least one visual representation can be captured and can be associated with: a thread on at least one end of at least one of the tubulars before the make-up of the threaded connection; an orientation of the tubulars and threads relative to one another at least one of before, during, and after the make-up of the threaded connection; a surface treatment on at least a portion of at least one of the tubulars; a lubrication applied to the thread on at least one of the tubulars before the make-up of the threaded connection; or a thread on at least one end of at least one of the tubulars after the make-up and break-out of the threaded connection.

The analysis can be implemented with an artificial intelligence model including: a large language model trained by a dataset of training visual representations so data in the at least one visual representation can be analyzed directly with the large language model for the at least one connection error; a large language model trained by a dataset of training visual representations so data in the at least one visual representation input into the large language model can be converted into an output of descriptive text to be analyzed; or a convolutional neural network trained by a dataset of training visual representations so data in the at least one visual representation can be analyzed directly with the convolutional neural network for the at least one connection error.

According to another aspect, a method disclosed herein is used in running tubulars. The method comprises initiating make-up of threaded connections between the tubulars with connection equipment; capturing, with at least one imaging sensor, visual representations associated with the make-up of the threaded connections; receiving, with a control system, assessments of initial ones of the threaded connections, the assessments being user-indicated and being based on at least one connection error associated with the threaded connections; training an artificial intelligence model implemented on the control system with the visual representations based on the assessments; analyzing, in an analysis with the trained artificial intelligence model implemented in a computing environment, subsequent ones of the visual representations for the at least one connection error associated with the threaded connections; and providing, with the control system, outputs indicative of the subsequent threaded connections based on the analysis.

A system disclosed herein is used in running tubulars on a rig. The system comprises: at least one imaging sensor, an output interface, and a control system. The at least one imaging sensor is configured to capture at least one visual representation associated with make-up of threaded connections between the tubulars. The output interface is configured to provide an output on the rig. The control system is in communication with the at least one imaging sensor and the output interface. The control system is configured to: analyze, in an analysis with an artificial intelligence model implemented on the control system, the at least one visual representation for at least one connection error associated with the threaded connection; and provide, based on the analysis, a result for the threaded connection in the output of the output interface.

The foregoing summary is not intended to summarize each potential configuration or every aspect of the present disclosure.

### BRIEF DESCRIPTION OF DRAWINGS

FIG. 1A illustrates connection equipment used with a system to make-up, evaluate, and analyze a threaded connection of tubulars according to the present disclosure.

FIGS. 1B-1C illustrate cross-sectional views of different configurations for threaded connections between tubulars according to the present disclosure.

FIGS. 2A-2B schematically illustrate the connection equipment and the system of present disclosure during stages of operation.

FIG. 3A illustrates a process of implementing several check modules for the disclosed system.

FIG. 3B illustrates a check module for the disclosed system.

FIG. 3C illustrates a process of rejecting the makeup of a threaded connection according to the present disclosure.

FIG. 4A illustrates one example of an imaging system for capturing visual representations of pin and box threads for a threaded connection.

FIG. 4B illustrates a schematic view of a visual representation of thread captured in the imaging system.

FIG. 5 illustrates a process of integrating the disclosed system into making-up threaded connections for tubulars.

FIG. 6 illustrates a process of making up and evaluating threaded connections of tubulars according to the present disclosure.

FIG. 7 schematically illustrates a natural language processing platform for automated training and performance evaluation by the disclosed system.

FIG. 8 schematically illustrates a convolutional neural network used for analysis by the disclosed system.

FIG. 9 schematically illustrates a framework to train a neural network for the analysis of the disclosed system.

### DETAILED DESCRIPTION OF THE DISCLOSURE

Systems and methods are disclosed for automated make-up and evaluation of tubular connections in a drilling operation. Captured images of the make-up of the tubular connections are analyzed using an artificial intelligence model.

### A. Connection Equipment and Control System

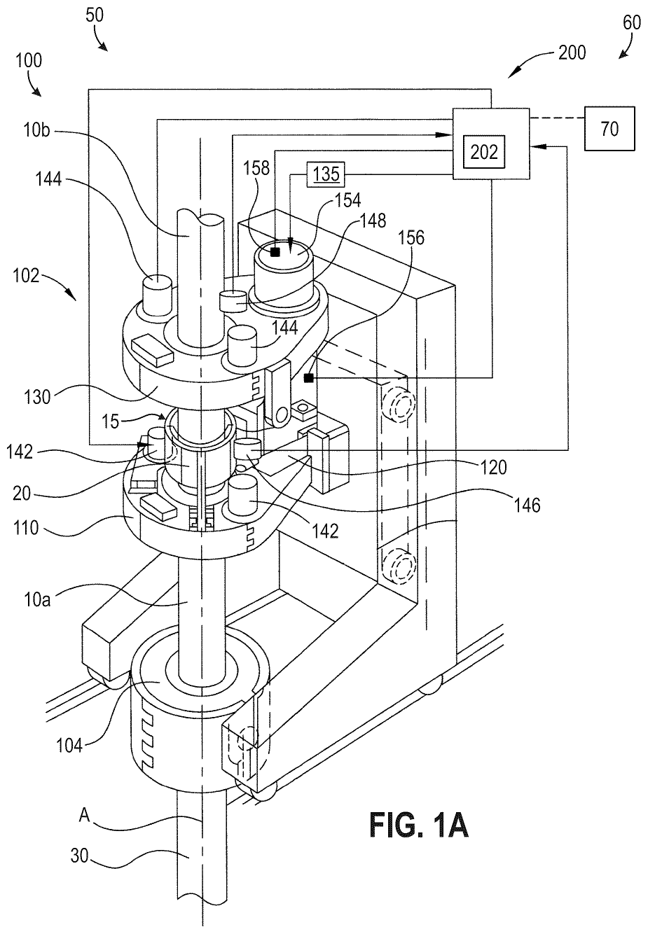

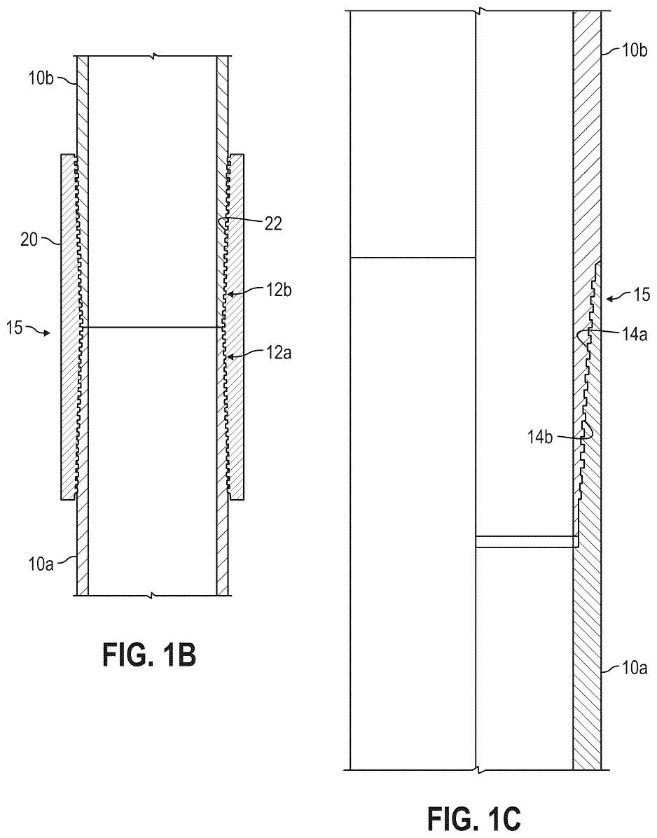

FIG. 1A is a schematic perspective view of a control system 50 according to the present disclosure to evaluate and analyze threaded connections 15 of tubulars 10a-b made-up using connection equipment 100 during tubular running. The connection equipment 100 includes a tong assembly 102 and a spider 104, and the control system 50 includes a connection system 200 having a controller 202 for controlling the tong assembly 102 during a make-up process. The control system 50 also includes components of a computing environment 60 for evaluating and analyzing threaded connections 15 between tubulars 10a-b. The computing environment 60 can use the connection system 200 and/or remote systems 70. As discussed below, the evaluation and analysis performed by the control system 50 uses visual representations (e.g., images, scans, etc.) of the threaded connections 15.

The “threaded connections” 15 to be analyzed can include features of: a proposed threaded connection before make-up, a made-up threaded connection after make-up, a broken threaded connection after make-up and break out, etc. Any visual representations, analysis, evaluation, determination, and results for “threaded connections” disclosed herein can refer to: the thread of one or both tubulars 10a-b before or after make-up, the thread after an equipment error of the connection equipment 100, surface treatment (lubrication, coating etc.) on at least a portion (thread, pipe body, etc.) of a tubular 10a-b (e.g., lubrication or coating on the thread before make-up and/or after make-up and break out), orientation of the tubulars 10a-b before or after make-up, etc.

The tong assembly 102 can include a power tong 130 and a backup tong 110 and can be operated according to an automated make-up process, such as disclosed in U.S. Pat. No. 10,808,42, which is incorporated herein by reference. During operation, the tong assembly 102 is placed on a rig (not shown) and can be moved on the rig relative to a central axis A of a tubing string 30. (The rig can be a drilling rig to drill wells, such as oil or water wells, in a subsurface formation. The rig can be an oil rig with facilities to extract and process petroleum and natural gas from the ground. For example, the rig can be an on-shore rig or an offshore rig, such as an oil platform or an oil and/or gas production platform.) The tong assembly 102 is positioned above the spider 104 on a drilling rig so a new tubular 10b can be added in a threaded connection 15 to a lower tubular 10a of the tubing string 30 while the tubing string 30 rests in the spider 104. (As will be appreciated, the tong assembly 102 can also be used to remove the upper tubular 10b from the tubing string 30 while the tubing string 30 rests in the spider 104.)

Different types of threaded connections 15 can be made up between the tubulars 10a-b. FIGS. 1B-1C illustrate two configurations of threaded connections 15, but others are possible for the purposes of the present disclosure. The threaded connection 15 in FIG. 1B shows a lower tubular 10a having a coupling 20 that is pre-made on a “mill end” of the lower tubular 10a. In particular, internal thread inside the bore 22 of the coupling 20 is first threaded onto a pin end 12a of the lower tubular. To make up the threaded connection 15, the threaded pin 12b on a “field end” of the upper tubular 10b is threaded into the coupling 20.

The threaded connection 15 in FIG. 1C shows a flush joint. The lower tubular 10a has a female (box) end 14a with internal (box) thread, and the upper tubular 10b has a male (pin) end 14b with external (pin) thread. The male end 14b of the upper tubular 10b is threaded to the female end 14a of the lower tubular 10a to make up the connection. Each tubular 10a-b would have male and female ends 14a-b, which can be joined together to create a tubing string during installation in a well. Other types of joints, such as a semi-flush joint, can be used.

During operation of the tong assembly 102 in FIG. 1A, a “field end” of the upper tubular 10b is aligned and initially set in the “mill end” of the lower tubular 10a. As noted above and shown here, the field end of the upper tubular 10b can have a threaded pin that threads into a coupling 20 already threaded onto the lower tubular 10a to make up the threaded connection 15 of the tubulars 10a-b. (As an alternative noted above, the upper tubular 10b can have a male threaded end that can thread into a female threaded end of the lower tubular 10a.)

The power tong 130 receives and clamps to the upper tubular 10b, while the backup tong 110 receives and clamps to the lower tubular 10a on top of the tubing string 30. For example, the backup tong 110 can clamp to the lower tubular 10a below the coupling 20. The power tong 130 rotates the upper tubular 10b while the backup tong 110 holds the lower tubular 10a stationery, causing relative rotation between the tubulars 10a-b and thereby making up the threaded connection 15 between the tubulars 10a-b. (As noted previously, the tong assembly 102 can break out the threaded connection 15 between the tubulars 10a-b depending of the direction of rotation.)

The power tong 130 and the backup tong 110 may be coupled together by a frame 120. Typically, the power tong 130 includes a side door to receive or release the upper tubular 10b, and the side door can close to clamp the upper tubular 10b in the power tong 130. Similarly, the backup tong 110 may include a side door, which may open to receive or release the lower tubular 10a and may close to clamp the lower tubular 10a in the backup tong 110.

One or more actuators 144 may be used to drive gripping pads in the power tong 130 to clamp the upper tubular 10b during operation. Also, one or more actuators 142 may be used to drive gripping pads in the backup tong 110 to clamp the lower tubular 10a and hold the lower tubular 10a stationery during operation.

The actuators 142, 144 may be hydraulic actuators, mechanical actuators, or other suitable actuators.

The actuators 142, 144 are connected to the controller 202 and may receive commands from the controller 202 to clamp, release, or adjust clamping force exerted against the tubulars 10a-b. The controller 202 may also be connected to other actuators, such as the actuators 142, 144 through a drive unit, such as a hydraulic power unit when the actuators are hydraulic actuators.

The power tong 130 may include a drive unit 135 configured to drive a motor assembly 154, which is configured to rotate the upper tubular 10b clamped in the power tong 130. In general, the motor assembly 154 may include a drive motor and a gear assembly. The motor assembly 154 may include a hydraulic motor assembly or an electric motor assembly. For example, the drive unit 135 may be a hydraulic drive circuit configured to drive a hydraulic motor of the motor assembly 154. As further shown, the motor assembly 154 and the drive unit 135 are connected to the controller 202c. The motor assembly 154 may receive commands from the controller 202 to rotate forward, backward, and at a target speed.

The tong assembly 102 also includes sensors 140 to measure data during operations. For example, the sensors 140 can include a turns counter 158 connected to the controller 202 to monitor the rotation of the power tong 130. The turns counter 158 may be an internal turns counter, such as a decoder connected to a drive shaft inside a gear box of the power tong 130. Therefore, the turns counter 158 connected to the controller 202 can be used to measure turns of the upper tubular 10b clamped in the power tong 130 during operation.

The sensors 140 can include a turns sensor 148, which is mounted on the power tong 130 and is configured to measure turns of the upper tubular 10b clamped in the power tong 130. Connected to the controller 202, the turns sensor 148 can send measurements to the controller 202. Measurements of the turns sensor 148 may be used to generate commands for rotational speed in a closed loop control during an automated make-up process according to the present disclosure. Measurements of the turns sensor 148 may also be used to evaluate the threaded connection 15 during an automated evaluation process according to the present disclosure. As will be appreciated, the turns sensor 148 may be any sensor capable of measuring rotation. For example, the turns sensor 148 may be contactless turns counter, such as an optical sensor or a laser sensor. Alternatively, the turns sensor 148 may be configured to contact a surface to be measured for rotation. For example, the turns sensor 148 may be a friction wheel sensor.

The sensors 140 can also include a turns sensor 146, which can be mounted on the backup tong 110 can be configured to measure rotation of the upper tubular 10b clamped in the backup tong 110. The turns sensor 146 may be positioned to measure rotation of the upper tubular 10b or the coupling 20 relative to the backup tong 110. Measurements of this other turns sensor 146 may be used to detect backup slippage and/or coupling rotation during an automated make-up process according to the present disclosure. Measurements of the turns sensor 146 may also be used to evaluate the threaded connection 15 during an automated evaluation process according to the present disclosure. The turns sensor 146 may be any sensor capable of measuring rotation. For example, the turns sensor 146 may be contactless turns counter, such as an optical sensor or a laser sensor. Alternatively, the turns sensor 146 may be configured to contact a surface to be measured for rotation. For example, the turns sensor 146 may be a friction wheel sensor.

The sensors 140 can also include one or more load cells 156 positioned to measure the torque applied to the tubulars 10a-b of the threaded connection 15 being made up or broken out by the tong assembly 102. For example, the load cell 156 may be disposed in a torque load path between the power tong 130 and the backup tong 110. Alternatively, the load cell 156 may be positioned to measure a displacement of the tong assembly 102. In turn, the measured displacement may be used to calculate the torque between the tubulars 10a-b in the tong assembly 102.

During an automated make-up process according to the present disclosure, measurements of the load cell 156 may be used to generate rotation command to the power tong 130. Likewise, measurements of load cell 156 may also be used to evaluate the threaded connection 15 during an automated evaluation process according to the present disclosure.

The controller 202 is connected to the tong assembly 102 and may include hardware and software for performing automated make-up operations and automated evaluation operations. The control system 50, the connection system 200, and the controller 202 may include various hardware, such as processors, programmable logic controllers (PLCs), one or more computers, and one or more mobile devices. The hardware of the controller 202 may be positioned together or at separate locations. For example, the controller 202 may include a PLC that is positioned in-situ with the tong assembly 102 for performing an automated make-up process. The connection system 200 may include a computer for performing an automated processes and may include one or more mobile devices that are located at remote locations. Communications between the connection system 200, the controller 202, and the tong assembly 102 may include wired and wireless communication. Computing and communications as disclosed herein may also be implemented in a computing environment 60, which can include the connection system 200, a remote system 70, such as a cloud-based system, and other elements of the disclosed control system 50.

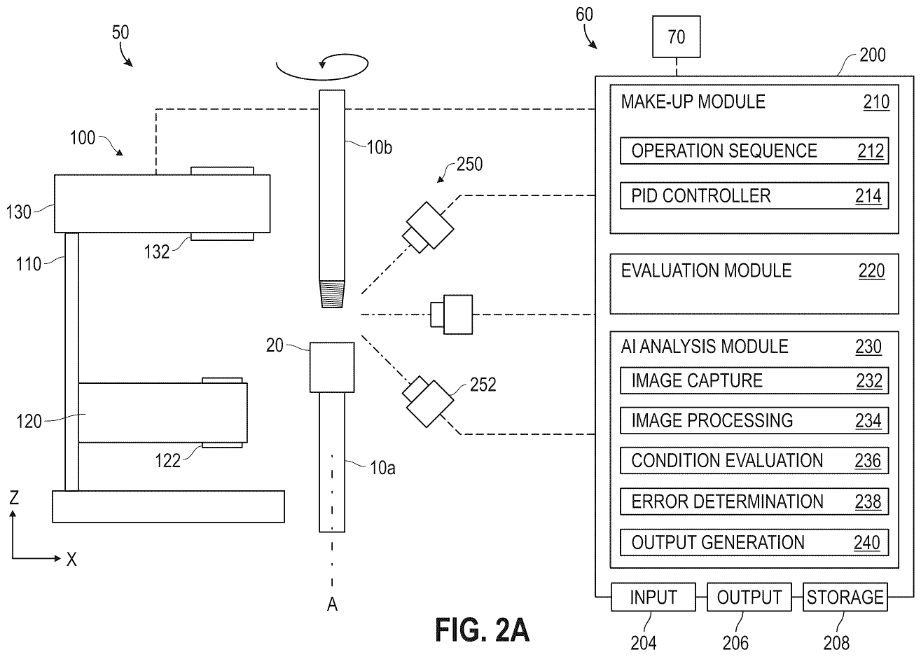

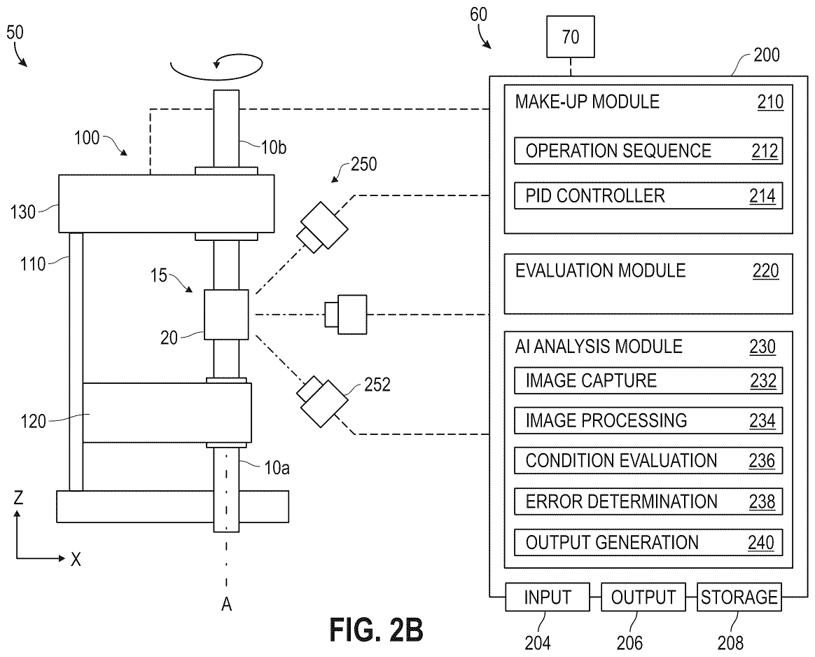

FIGS. 2A-2B schematically illustrates features of the connection equipment (e.g., tong assembly 102) and the connection system 200 in the disclosed control system 50. The tubulars 10a-b and the connection equipment (e.g., tong assembly 102) are shown before make-up in FIG. 2A and are shown after (or at least during) make-up in FIG. 2B.

The tong assembly 102 and the connection system 200 are connected by various data connections so the two can achieve a combined automated make-up process and automated evaluation process. The data connections may be wired connections, wireless connections, or virtual connections achieved by data sharing according to the function of the connection.

As discussed above, the connection system 200 includes a combination of hardware components and software programs configured to perform an automated make-up process and automated evaluation process. Even though the connection system 200 is shown as one block in FIGS. 2A-2B, hardware, and software components in the connection system 200 and other elements of the disclosed control system 50 may be integrated together or distributed in multiple locations in a computing environment.

The connection system 200 includes an automated make-up module 210 and an automated evaluation module 220. As indicated, each of these modules 210 and 220 can be automated in their operation, requiring little to no user intervention. The connection system 200 may also include one or more input interfaces 204, one or more output interfaces 206, and a storage device 208.

The input interfaces 204 may include keyboards, mice, push buttons, microphones, joysticks, or other user interface components. The input interfaces 204 are configured to receive tubular information, system configuration, commands from human operators, or other information related to the automated make-up process and the automated evaluation process according to the present disclosure. In some embodiments, predetermined values, such as an optimum torque value, a dump torque value, and a minimum and maximum torque value, may be input through the input interfaces 204 prior to making a threaded connection 15.

The output interfaces 206 may include monitors, printers, speakers, or other user interface components. The output interfaces 206 may be used to provide operating details to human operators. For example, during an automated make-up process, a technician may observe the operating details on an output interfaces 206, such as a video monitor or display. An operator may observe the various predefined values which have been input for a particular connection. Further, the operation may observe graphical information, such as the torque rate curve and the torque rate differential curve, in a graphical user interface on the output interfaces 206.

The storage device 208 may be a hard drive or solid-state drive that is connected to hardware components of the connection system 200. Alternatively, the storage device 208 may be located in the cloud for recording make-up data, tubular information, and other data related to an operation. The stored data may then be used to generate a post make-up report.

As noted, the make-up module 210 can perform an automated make-up process, such as disclosed in incorporated U.S. Pat. No. 10,808,472. For example, the automated make-up module 210 sends out commands to a motor assembly (not shown) to control the rotation direction and speed of the power tong 130 via one data connection to the motor assembly to control the power tong 130 during operation and via another data connection to the automated evaluation module 220, wherein data related to motor operation can be recorded and used for evaluation of the connection being made.

The automated make-up module 210 also sends out commands to the actuators (not shown) to generate forces in the backup tong 110 and the power tong 130 via a data connection to the actuators to control clamping and release of the tubulars 10a-b in the tong assembly 102 during operation and via another data connection to the automated evaluation module 220, wherein data related to clamping operation is recorded and used for evaluation of the connection being made.

Similarly, other operational commands from the automated make-up module 210 may also be connected to both the actuators and the automated evaluation module 220 for use in evaluation. In some configurations, operation parameters generated in the automated make-up module 210 but not sent out to any actuators, such as a determination of backup tong slippage, non-engagement between the tubulars 10a-b, may be sent to the automated evaluation module 220 via a connection.

Measurements of various sensors (e.g., load cell, turn counter, turns sensor, etc.) may be sent to the automated make-up module 210 and the automated evaluation module 220 through data connections for control and evaluation.

Looking at the connection system 200 in FIG. 2A in more detail, the automated make-up module 210 is configured to enable an automated make-up (or breakout) process. The automated make-up module 210 may operate on a programmable logic controller (PLC) that is connected to actuators (not shown) and sensors (not shown) of the tong assembly 102. The automated make-up module 210 may include a control program that generates commands to control rotational speed of the power tong 130 according to the measured torque applied between the tubulars 10a-b in the tong assembly 102 or other operating conditions.

The make-up module 210 includes an operating sequence program 212 and a PID controller program 214. When operated, the operating sequence program 212 generates commands for the tong assembly 102 to perform an automated make-up process or automated breakout process. For example, the operating sequence program 212 sends commands to the tong assembly 102 to perform a plurality of steps for making up or breaking out a threaded connection 15. The PID controller program 214 is configured to control the tong assembly 102 at a certain stage of a make-up process to perform an automatic speed reduction operation to stop rotation when a threaded connection 15 is made. The PID controller program 214 may be activated by the operating sequence program 212 when a trigger condition occurs. The trigger condition may include a measured torque between the tubulars 10a-b reaches a predetermined value, rotation of the tubular has been performed for a predetermined time duration, or a predetermined turns is rotated between the first and second tubulars 10a-b.

During operation, the automated make-up module 210 monitors various sensors (not shown) of the tong assembly 102, generates commands based on the sensor measurements, and sends out command signals to various components in the tong assembly 102 to complete the operation.

The automated evaluation module 220 is configured to automatically evaluate the threaded connection 15 between the tubulars 10a-b based on process parameters and sensor measurements made during make-up. After the threaded connection 15 is made using the automated make-up module 210, the threaded connection 15 can be evaluated by a connection evaluator 222 based on the functioning of the connection equipment (e.g., power tong 102) and its sensors in making-up the threaded connection 15. For example, the connection evaluator 222 can use an automated evaluation process, such as disclosed in U.S. Pat. No. 10,844,675 and U.S. Pat. No. 10,969,040, which is incorporated herein by reference. Any equipment error associated with over-torquing, under-torquing, improper connection speeds, and the like can be evaluated by the connection evaluator 222.

More particular to the subject matter of the present disclosure, the threaded connection 15 can be evaluated by an artificial intelligence (AI) analysis module 230 based on visual representations (e.g., images) to determine whether the threaded connection 15 is acceptable or should be rejected and remade due to one or more connection errors. The AI analysis module 230 addresses the need for enhanced quality control and documentation in the process of making-up threaded connections 15 between pipes and couplings in oil drilling operations. As noted, current methods rely heavily on manual inspections, which are prone to human error and inconsistency. Additionally, existing methods typically only perform detailed inspections after a failure has occurred, making it difficult to prevent issues proactively. The AI analysis module 230 disclosed herein provides a systematic approach to inspect and document thread conditions, alignment, and the application of lubricants before connections are made, thereby improving overall safety and reliability.

As shown here, the AI analysis module 230 can be integrated into the disclosed connection system 200, which has existing rig process controls, such as the make-up module 210 and evaluation module 220. Of course, the AI analysis module 230 can operate independently and can be implemented on a remote system 70 or elsewhere in the computing environment 60 of the disclosed control system 50, providing flexibility in implementation. Data can be evaluated on-site, in the cloud, or remotely by an operator, ensuring that expert analysis is available regardless of location.

Briefly, the AI analysis module 230 obtains detailed visual representations (e.g., images) captured of the connection's features (threads, pin end, box end, tubulars 10a-b, lubrication, coating, etc.), recording their conditions and ensuring proper documentation for future reference and root cause analysis. To enhance the overall quality and reliability of the threaded connections 15, the AI analysis module 230 evaluates the features—e.g., by ensuring that the threads and tubulars 10a-b are free from damage, that the proper type of thread is setup, that lubricant is correctly applied, that the coating is present and intact, etc.

The AI analysis module 230 combines imaging technology with real-time inspections and documentation in a proactive manner, rather than a reactive one. The AI analysis module 230 integrates multiple layers of quality control (thread type identification, damage detection, lubricant application verification, etc.) into a single automated system that can function either independently or within existing rig control systems. The ability to perform these inspections and analyses before making connections and to document them comprehensively for later review represents a novel approach in the field of tubular running systems.

As schematically shown in FIG. 2A, the AI analysis module 230 can employ an imaging system 250 installed at the location on the rig where tubulars 10a-b and couplings are connected. Using image capture (232), the AI analysis module 230 can use the imaging system 250, having one or more imaging sensors 252, such as cameras, terahertz scanners, or mechanical probes, to capture visual representations (“images”) of both internal and external threads, as well as of the tubulars 10a-b themselves. As the tubulars 10a-b and coupling 20 are brough together for connection as shown in FIG. 2A, for example, the imaging system 250 captures “images” of the threads and pipe surfaces. Likewise, after the threaded connection 15 is made-up as shown in FIG. 2B, the imaging system 250 can capture “images” of the pipe surfaces and other aspects of the threaded connection 15.

The images can be optical images, high-resolution camera images, far-infrared radiation scans, topographical scans, or other types of visual mappings of the threads, tubular surfaces, surface treatments (lubrication, coating, etc.) and other features. These images can be obtained by one or more cameras, terahertz scanner, topographical scanner, tactile scanner or probe, etc.

In general, obtaining the visual representation (“images”) of the surface(s) of the threads, tubulars 10a-b, surface treatments (lubrication, coating, etc.) and other features can be achieved through various techniques depending on the required resolution, material properties, and other factors. Therefore, selection of the particular method can be based on the material type, surface reflectivity, required resolution, and environmental conditions.

In optical methods, the imaging system 250 can use digital cameras 252 to obtain digital images. Structured lighting can be used to image more of the typography of the associated surface(s) of the feature(s) in the digital camera image. For example, a projector can cast a series of patterns (stripes or grids) onto the surface(s), and the camera 252 can capture the distortion caused by surface contours. Photogrammetry can be used by capturing multiple images of the surface(s) from different angles using several cameras 252 at the same time so the topography can be reconstructed using algorithms.

A laser scanning (LIDAR) device 252 can be used by sweeping a laser beam in a laser scan over the surface(s) of the feature(s). The reflected light measures distance to generate a typographical image. A terahertz scanning device 252 can be used by subjecting the surface(s) of the feature(s) to terahertz waves. A holographic imaging device 252 can use coherent light of a laser to create interference patterns, reconstructing profiles of the surface(s) of the feature(s). Various wavelengths (e.g., visible, infrared, UV) can be used together to collect comprehensive surface data.

In contrast to optical devices, contact-based devices can be used to “image” the surface(s) of the feature(s). In brush scanning, a brush or stylus 252 with sensors can physically trace the surface, recording height variations. Alternatively, a fine stylus 252 can be dragged across the surface, with its displacement measured mechanically or electronically to perform stylus profilometry.

Rough surface profiling can use acoustic/echo-based devices 252, such as ultrasound scanning using ultrasonic waves reflected off the surface so the echo time or intensity can be used to map topography. Sound waves emitted over the surface are analyzed for topographical irregularities.

Finally, capacitive or electromagnetic devices 252 can be used. In capacitive sensing, changes in capacitance can be measured as a sensor 252 hovers over the surface to detect contours. In eddy current scanning, variations in eddy currents induced by electromagnetic fields in the conductive surfaces can reveal surface topography.

A combination of these methods can be used to obtain the visual representations to be analyzed by the AI analysis module 230. For example, tactile scanning (brush or stylus) can be combined with cameras or sensors. Digital images and image processing may prove to be the most accessible for analysis on the rig floor.

In image processing (234) of the AI analysis module 230, the images are processed using image recognition software to detect conditions of the features (e.g., any issues or damage of the thread, pipe ends, tubulars 10a-b, surface treatment, lubrication, coating, etc.). In condition evaluation (236), the AI analysis module 230 evaluates the conditions against associated specifications (e.g., thresholds, tolerances, quality measurements, etc.), which define requirements for the threaded connection 15. Based on the evaluation, the AI analysis module 230 determines whether the conditions are indicative of any connection errors using an error determination (238).

For instance, the AI analysis module 230 can analyze the visual representations captured and processed of the threads, the surface treatment, lubrication, coating, alignment, orientation, and other information (both before and after connection) to determine an acceptable/unacceptable threaded connection 15 according to one or more possible connection errors. The connection errors can include a lack of connection, misalignment of the threads, misalignment of the tubulars 10a-b, galling of the thread, damaged thread, improper lubrication on the threads, missing or damaged coating on the threads, and other errors detailed herein.

In output generation (240), the AI analysis module 230 provides output for the operator and/or other components of the disclosed system 50. As part of the output generation (240), the AI analysis module 230 can also record the conditions of the threads and tubulars 10a-b, creating a comprehensive log that includes images and analysis results.

Should no connection error be found, for example, the AI analysis module 230 can provide outputs that verify the correct application of lubricant, identify that the correct the thread type is used, indicate that no thread damage is present, show proper alignment, etc. Should a connection error be identified, the AI analysis module 230 can provide a rejection of the threaded connection 15. If any issues are detected (e.g., damages, misalignment, improper lubricant application), for example, the AI analysis module 230 generates alerts for immediate review by operators. The connection system 200 can then receive a user-initiated command to initiate the make-up of the threaded connection. Additionally, automated controls can be sent to the connection equipment 100 so the connection between the tubulars 10a-b can be broken, and additional handling can be performed. For example, an automated command can be sent to the connection equipment 100 to initiate the make-up of the threaded connection.

In general, providing outputs or results for the threaded connection based on the analysis can include indicating a presence of the at least one connection error, indicating a rejection of the threaded connection, indicating an absence of the at least one connection error, indicating an acceptance of the threaded connection, and documenting the result of the analysis. These and other forms of output and results can be generated. In response to the outputs and results, the connection system 200 can operate in an automated fashion or can receive a user input either accepting or rejecting the threaded connection, which has not been made-up yet or has already been made-up.

### B. Process

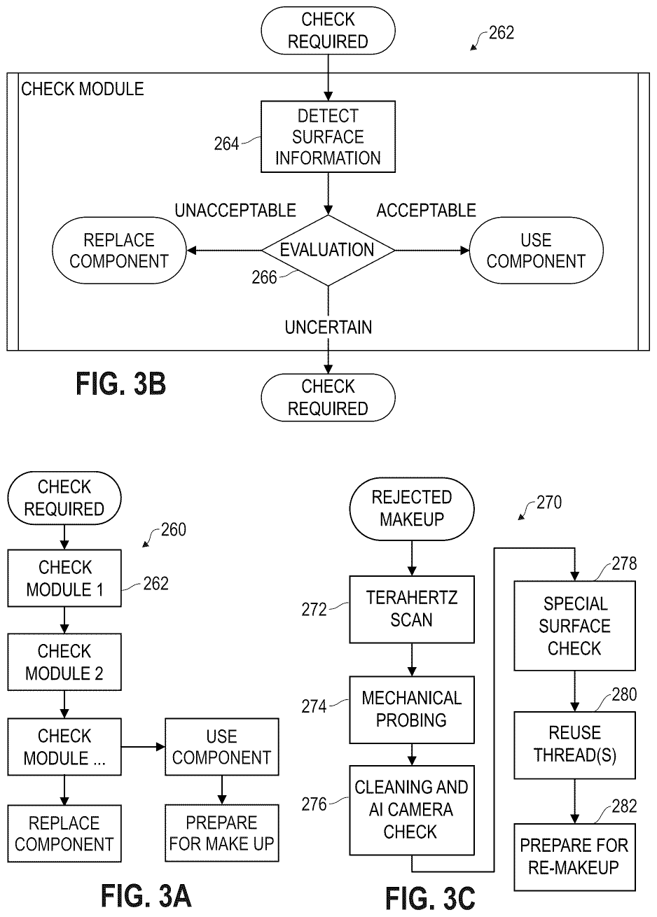

In FIG. 3A, the disclosed system 200 can be modular in nature, using a process 260 having one or more check modules 262 following the same principles. A number of check modules 262 can be used until a final decision is made to accept/reject a threaded connection 15 to be made-up, accept/break out a threaded connection 15 already made-up, accept/replace a tubular component for a threaded connection 15, accept/reject lubrication applied, etc. The check modules 262 can evaluate any one or more of: the condition of the threads of the tubulars 10a-b to be connected, the shape of the pin/box ends of the tubulars 10a-b, the alignment of the threads, surface treatment on thread and/or pipe body, the lubrication applied to the threads, the coating on the threads, the alignment of the tubulars 10a-b, etc. One or more of these check modules 262 can be performed before the make-up of the threaded connection 15, while others of the one or more check modules 262 can be performed during or after the make-up of the threaded connection 15. Moreover, one or more of these check modules 262 can be performed again after a threaded connection 15 has been broken out before a decision is made to reinitiate the make-up of the tubulars 10a-b.

For example, the one or more check modules 262 initiated before the make-up of the threaded connection 15 can include a first check module to check the thread, a second check module to check alignment, and a third check-module to check the lubrication. If the checks are positive, preparation for making up the threaded connection (i.e., threading) can follow automatically. These checks can be performed before the initial make-up of the connection is performed.

In another example, the one or more check modules 262 can be performed after a previous make-up has failed and the threaded connection 15 needs to be repeated. One of the check modules 262 for this situation can include a check module to check the thread for damage resulting from the failed make-up.

As shown in FIG. 3B, an example check module 262 of the disclosed system 200 is shown and involves a check of the threads on the pin and box ends of the tubulars 10a-b to be connected. A detection procedure 264 is performed to obtain surface information of the threads on the pin and box ends of the tubulars 10a-b to be connected. An evaluation 266 is performed on the detected surface information to determine if the thread is either acceptable or unacceptable. If acceptable, the tubular component can be used, and preparation for making up the connection (i.e., applying lubricant and threading) can follow automatically. Otherwise, the tubular component is indicated for replacement, if the thread is unacceptable. If the evaluation process returns an ‘uncertain’ outcome, the check module may repeat the detection and evaluation.

Other check modules 252 noted above can have comparable steps of detecting at least one condition associated with the threaded connection 15 captured in the at least one visual representation (e.g., detecting the condition of the thread, tubular, end, lubrication, or other feature) (264); evaluating the at least one detected condition with respect to at least one specification (266); and determining, based on the evaluation, whether the condition is acceptable or not. The check module 262 can then provide a result, such as a rejection or acceptance, based on the determination so the threaded connection 15 can be initiated or a following check can be performed on another feature.

As briefly noted above, a check module 262 can be performed after a threaded connection 15 has been broken out so a decision can be made to reinitiate the make-up of the tubulars 10a-b. FIG. 3C shows an example sequence 270 of handling a rejected make-up of a threaded connection 15. As will be appreciated, other sequences are possible. In one check, a terahertz scan can be used to scan through any dirt and lubricant on the threads to detect surface information of the thread and determine if the threaded connection 15 can be remade (Block 272). If the result of the terahertz scan is uncertain, mechanical probing using tactile scanning can be performed through any dirt and lubrication on the threads to detect surface information of the thread and determine if the threaded connection 15 can be remade (Block 274). If the result of the mechanical probing is inconclusive, then the threads can be cleaned, and imaging can be used to obtain an image of the threads (Block 272). The imaging can point out any suspicious areas requiring a special surface check (Block 274). For example, the special surface check can look for evidence of galling, wear, metal transfer, and cross-threading of the thread. If all of the checks produce an acceptable result, the threads can be reused (Block 280), and operations prepare the threads for a second make-up (Block 282).

As disclosed herein, any number of suitable imaging devices can be used to obtain a visual representation of the features (thread, pin end, box end, tubular, lubrication, etc.) of a threaded connection 15 for analysis as disclosed herein. Several imaging devices can be arranged separately about the rig area to capture visual representations of several features at the same time. One imaging device can obtain visual representations of the same feature at different times or to obtain visual representations of different features at different times. These and other combinations can be used.

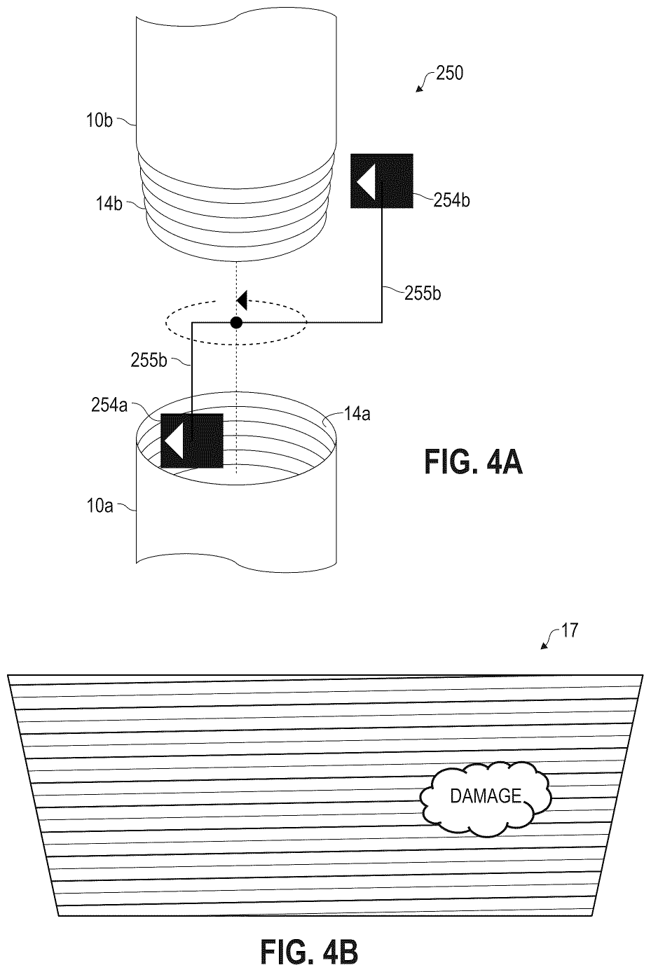

As one example, FIG. 4A illustrates an example of an imaging device 250 that scans the box thread 14a and pin thread 14b of tubulars components 10a-b to be joined in a threaded connection. The imaging device 250 includes imaging sensors 254a-b as required by the different check modules, such as cameras, laser sensors, brush/cleaning device, etc. to work on/scan the threads. As shown here, the imaging device 250 includes first and second imaging sensors 254a-b. The first imaging sensor 254a is disposed on a first arm 255a to image the internal thread 14a on the pin end of a first tubular component 10a, and the second imaging sensor 254b is disposed on a second arm 255b to image the external thread 14b onto the box end of a second tubular component 10b. The arms 255a-b can be rotated at a rotational center about a rotational axis so the imaging information of both threaded surfaces can be obtained in a 360-degree rotation at the same time.

FIG. 4B schematically shows a 360-degree visual representation 17 of the threaded surface of the pin or box thread (14a-b) obtained with the imaging device (250) as in FIG. 4A. Damage can be captured in the visual representation and can be detected by the image processing disclosed herein.

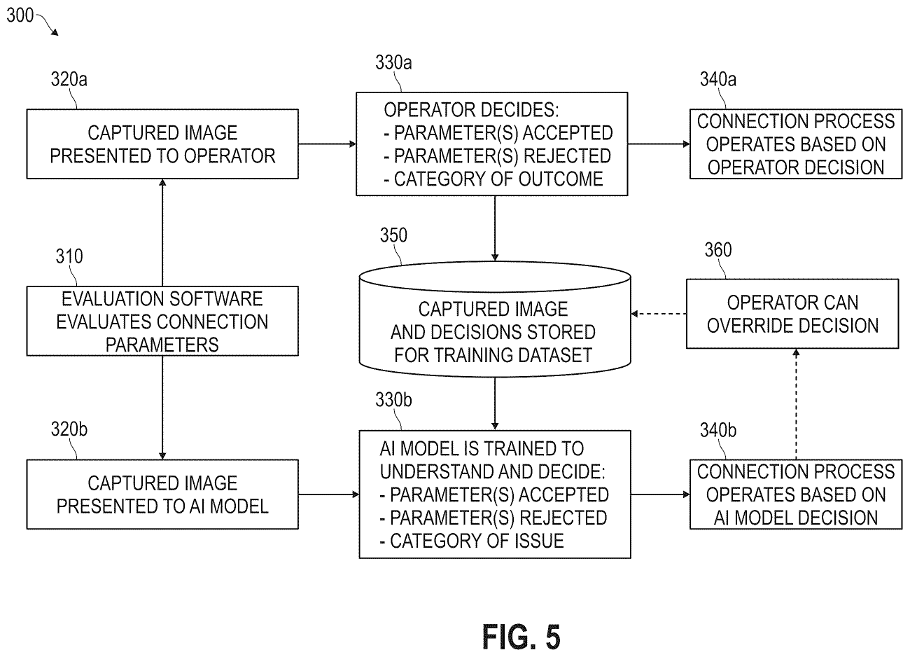

FIG. 5 illustrates a process 300 of integrating the disclosed systems and methods into making-up threaded connections 15 for tubulars 10a-b. (Reference numerals to elements in other figures are provided in the discussion below.)

Initially during real-time operations of the process 300, the connection equipment 100 and the connection system 200 are used to make-up threaded connections 15 between tubulars 10a-b in tubular handling operations. The connection system 200 evaluates the threaded connections 15 by obtaining visual representations (e.g., capturing images) of the pipe, threads, alignment, lubrication applied, make-up, etc. (Block 310). These captured images are presented to the operator (Block 320a), who is operating the connection equipment 100 making up the threaded connection 15 between the tubulars 10a-b.

The operator reviews the one or more captured images, which can be output on a display or other output interface 206. The operator decides to accept or reject the threaded connection 15 and also categorizes the outcome associated with the threaded connection 15 (Block 330a). The outcome can indicate whether there is any connection error in the threaded connection 15, including a lack of connection; a misalignment, damage thread, mismatched thread type, improper application of lubricant, etc.

The process 300 can then proceed based on the operator's decision or assessment of the threaded connection 15 (340a). If the threaded connection 15 is accepted, for example, additional handling operations can commence on the rig floor so the tubing string 30 can be run into the well. If the threaded connection 15 is rejected, the threaded connection 15 may be broken out by the connection equipment 100 so it can be made up again. Each operator's assessment and the captured image(s) on which it was based are stored to produce a training dataset for the AI analysis model of the process 300 (Block 350).

Eventually, a sufficient corpus of training data is produced offline. An AI model in the AI analysis module 230 is then trained using the large dataset of historical captured images and their corresponding assessments (the outcomes accepting or rejecting the threaded connection 15 as well as the category of the connection error). The trained AI analysis model can then be integrated into the existing software used for evaluating and controlling the connection equipment 100 and processes for making the tubular connections.

Now, during real-time operations, the evaluation module 220 evaluates the threaded connections 15 as before by capturing one or more images of the make-up process for processing (Block 320b). The captured images are then presented to the AI analysis model (Block 330b). The captured images may also be presented to the operator as before (Block 330a). The AI analysis model then analyzes the captured images and provides instant feedback on the quality of each threaded connection 15, including detailed descriptions of any detected connection errors (Block 330b). The control system (50) can output the results in any number of output formats, including a visual alarm to the operator, an audible alarm to the operator, a graphical user interface to the operator, and an automated control to the connection equipment to break the threaded connection 15.

The process 300 can then operate based on the AI analysis model's decision or assessment (Block 340b). Of course, the operator can override the AI analysis model's assessment, either accepting or rejecting the threaded connection 15 (Block 360). The results of the operator's override can be stored to build the repository of the training dataset (350) used to train and further refine the AI analysis model (330a-b). For example, the connection system 200 can receive choices of the model's assessments. The choices are user-indicated by the operator and can either confirm or decline the model's acceptance/rejection of the threaded connection 15. The AI analysis model implemented on the connection system 200 can then be trained with the captured images based on the user-indicated choices.

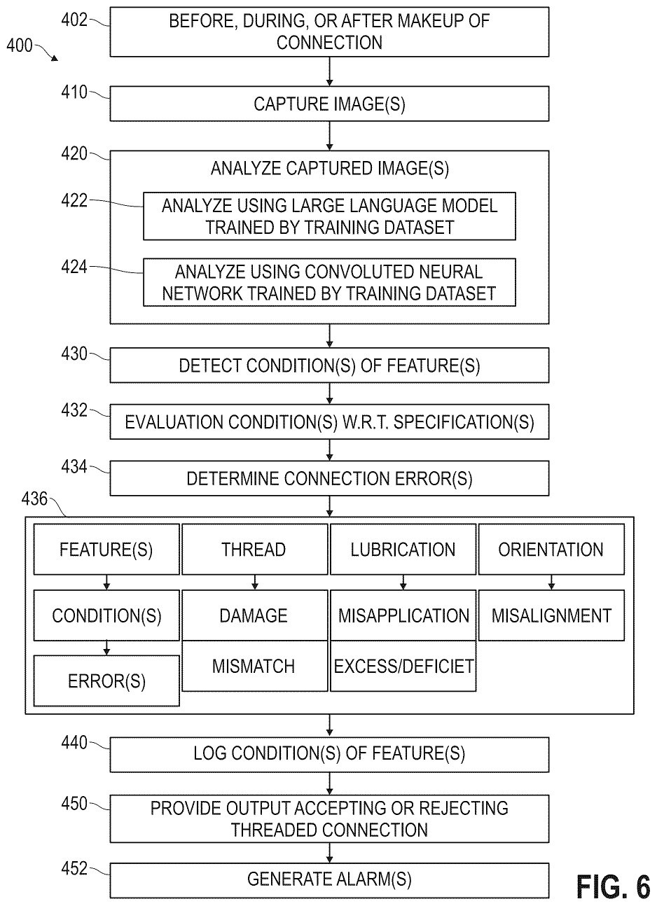

FIG. 6 illustrates further details of the process 400 of making up and evaluating threaded connections 15 of tubulars 10a-b according to the present disclosure. (Reference numbers to elements in other figures are provided in the discussion below.)

The process 400 is performed before, during, and/or after the make-up a threaded connection 15 of the tubulars 10a-b by the connection equipment 100 (Block 402). For example, the connection equipment 100 can include a tong assembly 102 that applies torque in rotating one of the tubulars 10b in turns relative to the other of the tubulars 10a. The make-up module 210 of the connection system 200 can automate and control the operation of the connection equipment 100 during the make-up operation.

In the process 400 either before, during, and/or after the make-up of the threaded connection 15, the AI analysis module 230 at least obtains visual representations (e.g., captures one or more images) of the features (e.g., the pin and box threads, the tubulars 10a-b, lubrication, orientation or alignment of the thread and tubulars 10a-b, etc.) for the threaded connection 15 of the tubulars 10a-b (Block 410).

The AI analysis module 230 then analyzes the captured images (Block 420) (Block 430). To analyze the captured images, the trained AI analysis model in the AI analysis module 230 can be implemented in the computing environment 60 to perform an analysis of the captured images for at least one connection error indicating an error in the threaded connection 15. As noted, computing implemented in the computing environment 60 can include using the connection system 200 and/or a remote system 70, such as a cloud-based system. Depending on the capabilities of the connection system 200, for example, computing for the trained AI analysis model may use the cloud-based system or other remote system 70.

The captured images can be saved in any suitable electronic format in storage. The trained AI analysis model of the AI analysis module 230 can access these captured images in storage to perform its analysis. The captured images can also be displayed on a monitor or other output interface 206 for the operator.

In the analysis (420), different artificial intelligence models and techniques can be used for the AI analysis models to analyze the captured images. In one artificial intelligence technique, the captured images are described using a large language model (LLM), and the generated text is then analyzed by the LLM to determine whether the threaded connection 15 is acceptable or has a connection error. For example, the analysis of the captured images can be implemented by a large language model (LLM) trained by a dataset of training images (Block 352). Image data in the captured images is input in the trained LLM, which converts the image data into descriptive text. In turn, the descriptive text is then analyzed with the artificial intelligence model, such as the same or different LLM, for a connection error.

In another artificial intelligence technique, a convolutional neural network (CNN) or an LLM is trained using historical training data to directly evaluate the captured images to determine whether the threaded connection 15 is acceptable or has a connection error. For example, the analysis of the captured images can be implemented by a convolutional neural network (CNN) trained by a dataset of training images. Image data in the captured images can be analyzed directly with the CNN for the connection error.

In analyzing the captured images for connection errors associated with the threaded connection 15, the AI model of the AI analysis module 230 detects conditions associated with the features of the threaded connection 15 captured in the images (Block 430); evaluates the detected conditions with respect to appropriate specifications (Block 432); and determines, based on the evaluation, whether the conditions of the features are indicative of connection errors (Block 434).

As will be appreciated, connection errors can compromise the integrity of the wellbore. A number of issues associated with the thread, tubulars 10a-b, make-up, and connection equipment may produce connection errors of concern according to the present disclosure. A few of the features, conditions, and connection errors are shown in Block 436. Different connection errors are described below.

For example, cross-threading can occur between thread on the pin and box ends of the tubulars 10a-b when the pin (male) thread and the box (female) thread are misaligned during make-up. The cross-threading can permanently damage the threads, leading to poor sealing and reduced load capacity. To prevent cross-threading, the AI analysis module 230 can detect misalignment of the thread to ensure proper alignment before the connection equipment 100 applies torque.

Over-torquing the threaded connection 15 occurs when more torque is applied to the threaded connection 15 than specified in the connection design. The over-torquing can produce thread galling, deformation, or loss of elasticity in the threaded connection 15, compromising its integrity. Any visual evidence of under-torquing that can be captured in a visual representation by the AI analysis module 230 can be analyzed by the AI model. Additionally, the evaluation module 220 for the connection equipment 100 controls the torque applied to the threaded connection 15 and can detect over-torquing during the make-up. If an over-torquing error is encountered during make-up, the connection system 200 can instruct the connection equipment 100 to break the threaded connection 15. New visual representations of the thread on the disconnected tubulars 10a-b can be obtained, so the AI analysis module 230 can evaluate the condition of the thread for any galling, deformation, or other damage from the over-torquing. If the conditions of the thread fail to satisfy specifications, then the AI analysis module 230 may instruct replacement of one or both tubulars 10a-b. Otherwise, the AI analysis module 230 may output acceptance of the tubulars 10a-b for a new make-up to be initiated.

Under-Torquing occurs when insufficient torque is applied during make-up. This produces a loose connection, which can lead to leaks, loss of structural integrity, or disengagement under load. Any visual evidence of under-torquing that can be captured in a visual representation by the AI analysis module 230 can be analyzed by the AI model. Additionally, the evaluation module 220 for the connection equipment 100 controls the torque applied to the threaded connection 15 and can detect under-torquing during the make-up. If an under-torquing error is encountered during make-up, the evaluation module 220 can instruct the connection equipment 100 to apply additional torque to the threaded connection 15 to reach the torque specification. Although under-torquing may be less likely to lead to damage, the evaluation module 220 can instruct the connection equipment 100 to break the threaded connection 15 so new visual representations of the thread on the disconnected tubulars 10a-b can be obtained, and the AI analysis module 230 can evaluate the condition of the thread.

Improper make-up speed occurs when excessive speed is used during the make-up process and can produce skipping thread engagement or galling. Any visual evidence of excessive make-up speed that can be captured in a visual representation by the AI analysis module 230 can be analyzed by the AI model.

Additionally, the evaluation module 220 for the connection equipment 100 controls the make-up speed applied to the threaded connection 15 and can detect excessive speed during the make-up. If an error in the make-up speed is encountered during make-up, the evaluation module 220 can instruct the connection equipment 100 to break the threaded connection 15. New visual representations of the thread on the disconnected tubulars 10a-b can be obtained, so the AI analysis module 230 can evaluate the condition of the thread for any galling, deformation, or other damage from the excessive make-up speed. If the conditions of the thread fail to satisfy specifications, then AI analysis module 230 may instruct replacement of one or both tubulars 10a-b. Otherwise, the AI analysis module 230 may output acceptance of the tubulars 10a-b for a new make-up to be initiated.

In some cases, the pipe body and/or the thread on the tubulars 10a-b may have a surface treatment, such as a coating or another treatment. In the oil and gas industry, the surface treatments for casings, drill pipes, threads, and similar equipment can be used to prevent corrosion, wear, and mechanical damage. These surface treatments vary depending on the operating environment and application.

In a common surface treatment, operators place lubrication (dope) on the thread of the tubulars 10a-b to be made-up. Insufficient lubrication can produce several issues with the threaded connection 15. For example, insufficient lubrication can lead to excessive friction during make-up, resulting in thread galling in which metal transfer occurs between thread and surfaces of the thread are damaged, potentially ruining the connection. Insufficient lubrication or use of the wrong type of lubricant can also reduce sealing effectiveness.

To prevent excessive friction, operators apply lubricant (dope) to the thread in the make-up procedures. The AI analysis of the visual representation of the lubrication applied to the thread can be evaluated by AI analysis module 230 to determine whether a correct or an incorrect application of lubrication has been performed. The investigated condition can include the amount of the lubrication applied and can include the type of lubrication used (based on color or other visual aspect). If the conditions of the lubrication fail to satisfy specifications, then the AI analysis module 230 may instruct reapplication of lubrication. Otherwise, the AI analysis module 230 may output acceptance of the lubrication for make-up to be initiated.

Improper cleaning of any dirt, debris, or old lubricant left on the threads can produce poor thread engagement and sealing, leading to leaks or structural weakness. The AI analysis of the visual representation of the thread by AI analysis module 230 can evaluate the thread to determine whether a correct or an incorrect cleaning has been performed. The investigated condition can include detecting any dirt, debris, old lubricant, and the like. If the conditions of cleanliness fail to satisfy specifications, then the AI analysis module 230 may instruct cleaning of the thread. Otherwise, the AI analysis module 230 may output acceptance of the thread for make-up to be initiated.

In response to improper lubrication, the lubrication can be cleaned from the thread so another analysis can be performed. The cleaning can be instructed and performed manually or may be automated by the connection equipment 100. In an alternative response to improper lubrication, the lubrication can be cleaned from the thread, and new lubrication can be applied to the thread. At this point, a new visual representation associated with the new lubrication can be captured, and the new visual representation can be analyzed for the at least one connection error.

In addition to lubrication, other surface treatments may be used on the threads and/or pipe bodies of the tubulars 10a-b. Some of the surface treatments can include a corrosion-resistant coating (e.g., epoxy coating, polyurethane coating, zinc coating, and fusion bonded epoxy (FBE)) and a thermal spray coating (e.g., tungsten carbide or chrome carbide coating on threads and high-wear areas to improve resistance to wear and corrosion, aluminum-cased coating, and ceramic coating). Other coatings can include a polymer coating (e.g., PTFE coating) to reduce friction and enhance chemical resistance), an elastomeric coating for flexible sealing and wear resistance, and a nano-coating (e.g., graphene-based coating resistant to corrosion and mechanical wear and sol-gel coating to provide hydrophobic surfaces and corrosion resistance). Even internal coatings can be used for the tubulars 10a-b and can include glass-reinforced epoxy, internal plastic coating, and ceramic liner.

Other surface treatments can include a chemical treatment, such as phosphating a protective layer on threads to improve lubricity and wear resistance for the threads, nitride hardening to enhance surface hardness and wear resistance, a black oxide coating to provide corrosion resistance and improve the adhesion of lubricants, and electroplating (e.g., chromium plating and nickel plating). Some other thread-specific surface treatments can include using a dry-film lubricant, such as a coating of molybdenum disulfide, to reduce friction and galling during makeup. Additionally, a thread compound that contains corrosion inhibitors and anti-seize properties for threaded connections can be used as a thread-specific surface treatment.

Similar to the evaluation of lubrication, one or more visual representations can be captured of a surface treatment applied to (or already present on) the thread and/or pipe body of one or both of the tubulars 10a-b. The AI analysis by AI analysis module 230 can detect the surface treatment in the visual representation and can evaluate the surface treatment with respect to at least one specification to determine an issue associated with the surface treatment. The capture, evaluation, and determination can be performed before the make-up of the threaded connection or may be performed after an unsuccessful make-up has been broken out. The evaluation and determination can look for any missing, damaged, or improper application of the surface treatment configured to be used for the threaded connection 15.

Structural issues associated with the tubulars 10a-b, pin, box, coupling 20, and thread can produce connection errors of concern during make-up of threaded connections 15. When the tubulars 10a-b are handled on the rig, dropping or striking of the tubulars 10a-b and coupling 20 during handling can damage and deform the pin and box. For example, the thread can be damaged, or the pin/box may be deformed out-of-round, making proper engagement impossible. Worn threads on any of the tubulars 10a-b can reduce performance, leading to leaks or failure under load. The AI analysis of the visual representation of the tubulars 10a-b, pin, box, and thread by the AI analysis module 230 can evaluate these features to determine whether any damage, deformation, out-of-round shape, wear, etc. is present. If the conditions fail to satisfy specifications, then the AI analysis module 230 may instruct replacement of the associated tubular 10a-b, coupling 20, etc. Otherwise, the AI analysis module 230 may output acceptance of the tubulars 10a-b for make-up to be initiated.

Misalignment between the tubulars 10a-b during make-up can produce connection errors of concern. When the tubulars 10a-b are not properly aligned during make-up, non-axial forces are applied to the threaded connection 15, leading to poor thread engagement and potential damage to threads. The AI analysis of the visual representation of the tubulars 10a-b can be evaluated by the AI analysis module 230 to determine whether the tubulars 10a-b are properly aligned. If the conditions fail to satisfy specifications, then the AI analysis module 230 may instruct realignment of the tubular. Otherwise, the AI analysis module 230 may output acceptance of the tubulars 10a-b for make-up to be initiated.

Finally, incompatible threads between the tubulars 10a-b and coupling 20 during make-up can produce connection errors of concern. Different thread profiles (e.g., API vs. premium connections) on the tubulars 10a-b and coupling 20 may be set up for connection at the rig. Naturally, mismatched thread profiles will lead to poor engagement, leaks, or mechanical failure. The AI analysis of the visual representation of the threads by AI analysis module 230 can be evaluated to determine whether the threads are compatible. If the condition fails to satisfy specifications, then the AI analysis module 230 may instruct replacement of the affected tubular. Otherwise, the AI analysis module 230 may output acceptance of the tubulars 10a-b for make-up to be initiated.

Addressing these errors requires rigorous adherence to procedures, proper equipment, and training for personnel to ensure the integrity of the threaded connections 15. To assist with rig operations, the AI analysis module 230 disclosed herein performs visual and dimensional inspection of the tubulars 10a-b, couplings 20, threads, and the like before, during, and after the make-up of the threaded connection 15.

The conditions of the features may be logged (Block 440). Finally, after determining and logging the features and conditions, the AI analysis module 230 provides an output accepting or rejecting the threaded connection 15 based on the analysis (Block 450). Various forms of output can be provided. For example, information may be displayed to the operator on a display or other output interface 206. In another example in response to the determined connection error, the trained AI analysis model may instruct the controller 202 to operate the tong assembly 102 to break-out the connection so a new make-up operation can be attempted. Also, an automated alarm may be generated notifying operators of an issue with the connection (Block 452).

### C. Natural Language Processing

As noted above, the disclosed systems and methods use AI techniques, such as a large language model (LLM) for image-based evaluations. In one technique, an LLM converts graphical data into descriptive text, which is then analyzed to determine the acceptability of the connection. In another technique, an LLM is trained directly with graphical representation to evaluate and classify the quality of the threaded tubular connections.

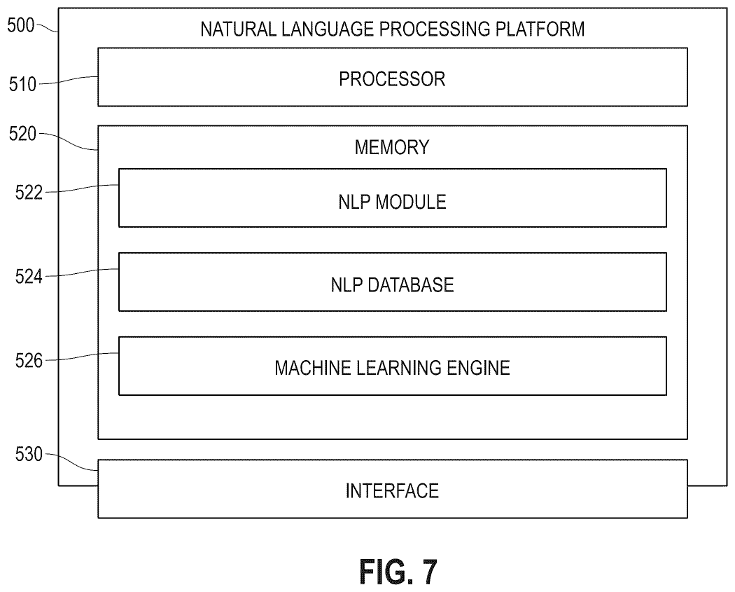

FIG. 7 schematically illustrates a natural language processing (NLP) platform 500 for automated evaluation and analysis of graphical representations in a computing environment (60). (Reference numerals to elements in other figures are provided in the discussion below.)

As noted, the computing environment (60) includes the connection system (200), the remote system (70), processes (300) discussed above, and other elements of the disclosed control system (50). The NLP platform 500 can be implemented on one or more computing devices configured to perform one or more of the functions described herein. For example, the NLP platform 500 can be implemented on the computing environment (60) of the control system (50), including the programmable logic controller 202 and/or one or more computers (e.g., laptop computers, desktop computers, tablets, etc.) at the rig.

As disclosed herein, the NLP platform 500 is configured to perform NLP processing techniques by (i) converting a graphical representation of the make-up operation of the threaded tubular connection into descriptive text and (ii) then analyzing the descriptive text to determine if the threaded connection 15 includes at least one connection error indicative of a failed connection. Additionally, the NLP platform 500 can maintain a model for dynamic performance evaluation and training that the NLP platform 500 may use to generate and analyze the descriptive text of the graphical representation.

The NLP platform 500 includes one or more processors 510, memory 520, and interface 530. A data bus (not shown) may interconnect the processor 510, the memory 520, and the interface 530. The interface 530 can include a graphical user interface for providing information to the operator of the connection equipment (100). The interface 530 can also include an equipment interface, such as a serial bus, a wireless connection, a wired connection, etc., to interface with the connection equipment (100) and any local programmable logic controller (202) of the connection equipment (100). Finally, the interface 530 can be a network interface configured to support communication between the NLP platform 500 and one or more networks (not shown).

The memory 520 includes one or more program modules having instructions that when executed by the processor 510 cause the NLP platform 500 to perform one or more functions. Additionally, the memory 520 includes one or more databases that store and maintain information that the program modules use. In some instances, the one or more program modules and/or databases may be stored in different memory units of the NLP platform 500 and/or stored by different computing devices that make up the NLP platform 500. As shown in this example, the memory 520 includes an NLP module 522, an NLP database 524, and a machine learning engine 526.

The NLP platform 500 may have instructions that direct the NLP platform 500 to execute advanced natural language processing techniques. The memory 520 may include several components or modules as illustrated. The NLP database 524 may store information used by the NLP module 522 in performing the functions disclosed herein. The machine learning engine 526 may have instructions that direct the NLP platform 500 to identify and summarize text in the graphical representations and to identify and describe features in the graphical representations indicative of at least one connection error associated with the threaded connection 15. The machine learning engine 526 can also set, define, and iteratively refine optimization rules and other parameters used by the NLP platform 500.

### D. Convolutional Neural Network

As noted above, the disclosed systems and methods use AI techniques, such as a convolutional neural network (CNN) for image-based evaluations. The CNN is trained directly with graphical representations to evaluate and classify the quality of the threaded tubular connections.

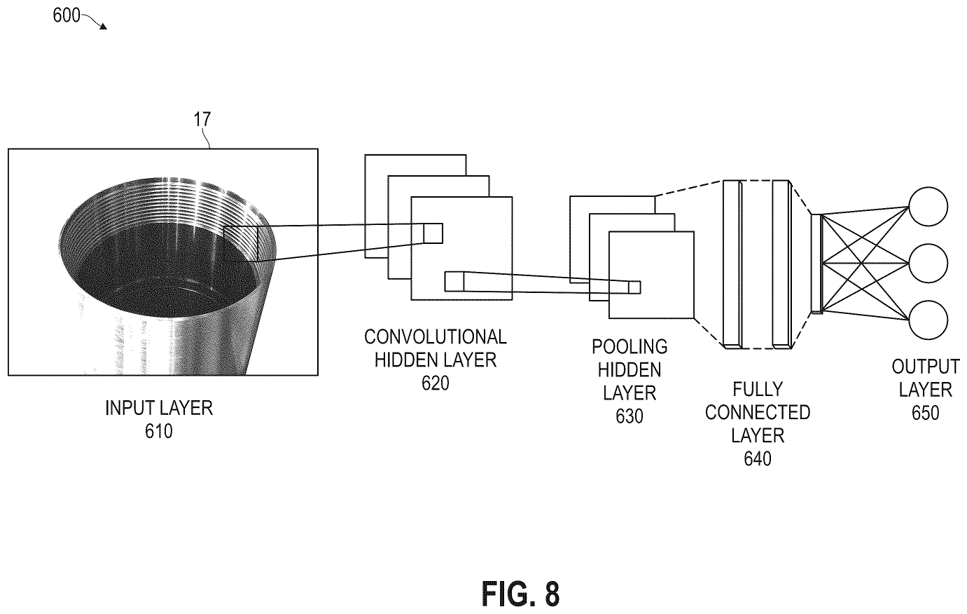

FIG. 8 schematically illustrates a convolutional neural network (CNN) 600 used for automated evaluation and analysis of graphical representations in a computing environment (60). (Reference numerals to elements in other figures are provided in the discussion below.)

Again, the computing environment (60) may include the connection system (200) and/or the remote system (70) and includes the connection processes (300) discussed above and other elements of the disclosed control system (50). The CNN 600 is a type of deep neural network (DNN) having three additional features: local receptive fields, shared weights, and pooling. An input layer 610 and an output layer 650 of the CNN 600 function similar to the input and output layers of a DNN. However, the CNN 600 is distinguished from a DNN in that hidden layers of the DNN are replaced with one or more convolutional hidden layers 620, pooling hidden layers 630, and fully connected hidden layers 640.

Using localized receptive fields, nodes in the convolutional hidden layers 620 receive inputs from localized regions in the previous layer. Meanwhile, using shared weights, each node in a convolutional hidden layer 620 assigns the same set of weights to the relative positions of a localized region.

The input layer 610 of the CNN 600 includes data representing a visual representation 17 (e.g., an image, a scan, etc. produced by the evaluation module 220). For example, the visual representation 17 can be a digital image, and the data can include an array of numbers representing the pixels of the image 17, with each number in the array including a value from 0 to 255 describing the pixel intensity at that position in the array. The image 17 can be passed through a convolutional hidden layer 620, an optional non-linear activation layer (not shown), a pooling hidden layer 630, and fully connected hidden layers 640 to get an output at the output layer 650. While only one of each hidden layer is shown in the present example, it is appreciated that multiple convolutional hidden layers 620, non-linear layers, pooling hidden layers 630, and/or fully connected hidden layers 640 can be included in the CNN 600.

The first layer of the CNN 600 is the convolutional hidden layer 620, which analyzes the image data of the input layer 610. Each node of the convolutional hidden layer 620 is connected to a region of nodes (pixels) of the input image 17 called a receptive field. The convolutional hidden layer 620 can be considered as one or more filters (each filter corresponding to a different activation or feature map), and each convolutional iteration of a filter can be considered a node or neuron of the convolutional hidden layer 620. For example, the region of the input image 17 that a filter covers at each convolutional iteration would be the receptive field for the filter. Each connection between a node and a receptive field for that node learns a weight and, in some cases, an overall bias such that each node learns to analyze its particular local receptive field in the input image 17. Each node of the convolutional hidden layer 620 will have the same weights and bias (called a shared weight and a shared bias). For example, the filter has an array of weights (numbers) and the same depth as the input.

The convolutional nature of the convolutional hidden layer 620 is due to each node of the convolutional layer being applied to its corresponding receptive field. At each convolutional iteration, the filter's values are multiplied by a corresponding number of the original pixel values of the image data. The multiplications from each convolutional iteration can be summed together to obtain a total sum for that iteration or node. The process is continued at a next location in the input image 17 according to the receptive field of the next node in the convolutional hidden layer 620. For example, a filter can be moved by a step amount to the next receptive field. Processing the filter at each unique location of the input volume produces a number representing the filter results for that location, resulting in a total sum value being determined for each node of the convolutional hidden layer 620.

The mapping from the input layer 610 to the convolutional hidden layer 620 is referred to as an activation map (or feature map). The activation map includes a value for each node representing the filter results at each location of the input volume. The activation map can include an array containing the various total sum values resulting from each iteration of the filter on the input volume. The convolutional hidden layer 620 can include several activation maps to identify multiple features in an image 17.

Applied after the convolutional hidden layer 620, the pooling hidden layer 630 simplifies the information in the output from the convolutional hidden layer 620. The pooling hidden layer 630 takes each activation map output from the convolutional hidden layer 620 and generates a condensed activation map using a pooling function. Max-pooling is one example of a pooling function that can be performed by the pooling hidden layer 630. The pooling hidden layer 630 may also use other known forms of pooling functions. The pooling function is applied to each activation map in the convolutional hidden layer 620.

In the final layer of connections in the CNN 600, the fully connected hidden layer 640 connects every node from the pooling hidden layer 630 to every one of the output nodes in the output layer 650. The fully connected hidden layer 640 obtains the output of the previous pooling hidden layer 630 (which should represent the activation maps of high-level features) and determines the features that most correlate to a particular class. For example, the fully connected hidden layer 640 can determine the high-level features that most strongly correlate to a particular class and can include weights (nodes) for the high-level features. A product can be computed between the weights of the fully connected hidden layer 640 and the pooling hidden layer 630 to obtain probabilities for the different classes. For example, if the CNN 600 is being used to predict that an object is a torque-turns curve, high values will be present in the activation maps that represent high-level features of a torque-turns curve.

### E. Training Neural Network

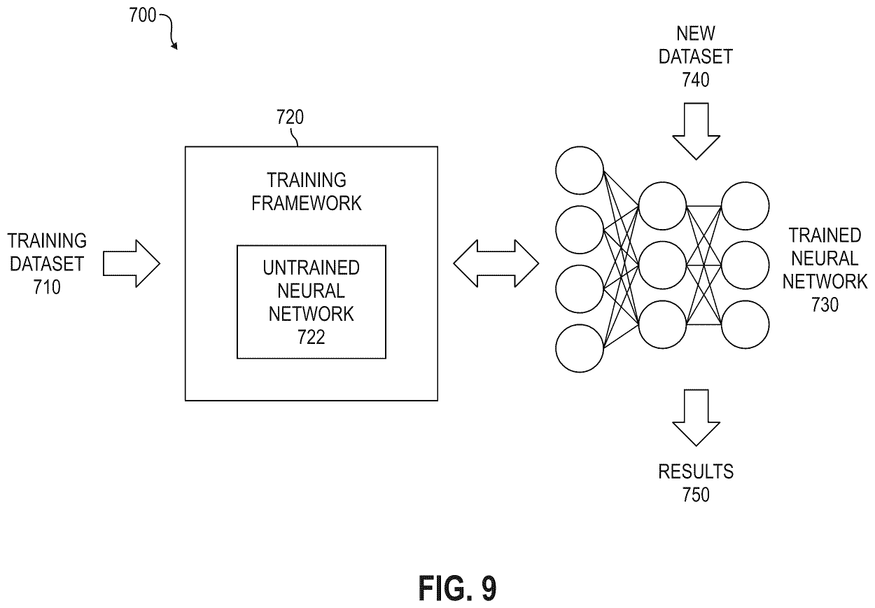

FIG. 9 illustrates an example of training and deployment of a deep neural network (DNN), such as the CNN 600 of FIG. 8. A network is structured for a task (e.g., to evaluate and analyze graphical representations for connection errors in threaded tubular connections). Once structured, the neural network is trained using a training dataset 710. As noted above with respect to FIG. 5, the training dataset 710 can include historical graphical representations produced during make-up of threaded connections 15, in which an operator has accepted or rejected a connection in a decision or assessment and has categorized the outcome or reason for that assessment.

To begin training the DNN 700, initial weights may be chosen randomly or by pre-training using a deep belief network. A training cycle can then be performed in either a supervised or unsupervised manner.

Supervised learning uses the training dataset 710 to teach an untrained neural network 722 to yield a desired output. The training dataset 710 includes inputs and desired outputs so the untrained neural network 722 can learn over time. Alternatively, the training dataset 710 can include inputs having known outputs so the outputs of the untrained neural network 722 can be manually graded. Either way, the untrained neural network 722 processes the inputs and compares the resulting outputs against a set of expected or desired outputs. Errors are then propagated back through the training cycle. The training framework 720 can change the weights that control the untrained neural network 722. The training framework 720 can also provide tools to monitor how well the untrained neural network 722 is converging towards a model suitable for generating correct answers based on known input data. The training process repeatedly occurs as the network weights are adjusted to refine the output generated by the neural network 722. The training process can continue until the neural network 722 reaches a statistically desired accuracy associated with a trained neural network 730. In turn, the trained neural network 730 can then be deployed to implement any number of machine learning operations to output a result 750 when given a new dataset of graphical representation during real-time operations in a tubular running operation.

Supervised learning is typically separated into two types of problems-classification and regression. Classification uses an algorithm to assign test data accurately into specific categories. Regression is used to understand the relationship between dependent and independent variables. Numerous different algorithms and computation techniques can be used in supervised machine learning, including but not limited to, neural networks, naïve bayes, linear regression, logistic regression, support vector machines (SVM), k-nearest neighbor, and random forest.

Unsupervised learning is a learning method in which the untrained neural network 722 uses algorithms to analyze and cluster unlabeled data. These algorithms discover hidden patterns or data groupings. Therefore, the training dataset 710 includes input data without any associated output data. The untrained neural network 722 can learn groupings within the unlabeled input and determine how individual inputs relate to the overall dataset. Unsupervised training can be used for three main tasks-clustering, association, and dimensionality. Clustering is a data mining technique that groups unlabeled data based on similarities and differences. This technique is often used to process raw, unclassified data objects into groups represented by structures or patterns in the information. Association is a rule-based method for finding relationships between variables in a given dataset.

This method is often used for market basket analysis. Dimensionality reduction is used when a given dataset's number of features (dimensions) is too high. This technique is commonly used in the preprocessing of data.

Variations of supervised and unsupervised training may also be employed. Semi-supervised learning is a technique in which the training dataset 710 includes a mix of labeled and unlabeled data of the same distribution. Incremental learning is a variant of supervised learning in which input data is continuously used to train the model further. Incremental learning enables the trained neural network 730 to adapt to the new data 740 without forgetting the knowledge instilled within the network during initial training.

Configurations of the present disclosure can be characterized by the following clauses:
1. A method (400) used in running tubulars (10) on a rig, the method (400) comprising:
initiating (402) a make-up of a threaded connection (15) between the tubulars (10) using connection equipment (100) on the rig;
obtaining (410) at least one visual representation (17) associated with the make-up of the threaded connection (15);
analyzing (420), in an analysis with an artificial intelligence model (230) implemented in a computing environment (60), the at least one visual representation (17) for at least one connection error associated with the threaded connection (15); and providing (450), with an output interface (206) in the computing environment (60), a result for the threaded connection (15) based on the analysis.
2. The method of Clause 1, wherein analyzing (420) in the analysis with the artificial intelligence model (230) implemented in the computing environment (60) comprises analyzing (420) with the artificial intelligence model (230) implemented on one or more of: a control system (50), a remote system (60), and a cloud-based system in the computing environment (60) in communication with the output interface (206); wherein providing the result for the threaded connection (15) based on the analysis comprises at least one of: indicating a presence of the at least one connection error; indicating a rejection of the threaded connection (15); indicating an absence of the at least one connection error; indicating an acceptance of the threaded connection (15); and documenting the result of the analysis;
wherein the method further comprises receiving a user input in the computing environment (60) either accepting or rejecting the threaded connection (15); and
wherein initiating the make-up of the threaded connection (15) comprises one of: sending an automated command in the computing environment (60) to the connection equipment (100) to initiate the make-up of the threaded connection (15); and receiving a user-initiated command in the computing environment (60) to initiate the make-up of the threaded connection (15).
3. The method of Clause 1 or 2,
wherein analyzing (420), in the analysis with the artificial intelligence model (230), the at least one visual representation (17) for the at least one connection error associated with the threaded connection (15) comprises:
detecting (430) at least one condition associated with the threaded connection (15) captured in the at least one visual representation (17);
evaluating (432), in an evaluation, the at least one detected condition with respect to at least one specification; and
determining (434), in a determination based on the evaluation, that the at least one condition of the threaded connection (15) is indicative of the at least one connection error; and
wherein providing (450) the result for the threaded connection (15) based on the analysis comprises providing a rejection of the threaded connection (15) based on the determination.
4. The method of Clause 1, 2 or 3,
wherein obtaining (410) the at least one visual representation (17) comprises capturing the at least one visual representation (17) associated with a thread (12, 14, 22) on at least one end of at least one of the tubulars (10) before the make-up of the threaded connection (15); and
wherein analyzing (420) the at least one visual representation (17) for the at least one connection error associated with the threaded connection (15) comprises:
detecting (430) at least one condition of the thread (12, 14, 22) captured in the at least one visual representation (17);
evaluating (432), in an evaluation, the at least one condition of the thread (12, 14, 22) with respect to at least one specification; and
determining (434), in a determination based on the evaluation, that the at least one condition of the thread (12, 14, 22) is indicative of at least one of: damage of the thread (12, 14, 22), galling of the thread (12, 14, 22), wear of the thread (12, 14, 22), a mismatch thread (12, 14, 22) profile of the thread (12, 14, 22), debris on the thread (12, 14, 22), old lubricant left on the thread (12, 14, 22), insufficient lubrication on the thread (12, 14, 22), and a deformation of the at least one end as the at least one connection error; and
wherein providing (450) the result for the threaded connection (15) based on the analysis comprises providing a rejection of the threaded connection (15) based on the determination.
5. The method of any one of Clauses 1 to 4,
wherein obtaining (410) the at least one visual representation (17) comprises capturing the at least one visual representation (17) associated with an orientation of the tubulars (10) and threads relative to one another at least one of before, during, and after the make-up of the threaded connection (15); and
wherein analyzing (420) the at least one visual representation (17) for the at least one connection error associated with the threaded connection (15) comprises:
detecting (430) the orientation captured in the at least one visual representation (17); and
evaluating (432), in an evaluation, the orientation with respect to at least one specification;
determining (434), in a determination based on the evaluation, at least one of a misalignment of the tubulars (10) and a misalignment of the threads (12, 14, 22) as the at least one connection error; and
wherein providing (450) the result for the threaded connection (15) based on the analysis comprises providing a rejection of the threaded connection (15) based on the determination.
6. The method of any one of Clauses 1 to 5, wherein obtaining (410) the at least one visual representation (17) comprises capturing the at least one visual representation (17) associated with a surface treatment on at least a portion of at least one of the tubulars (10), the surface treatment; and
wherein analyzing (420) the at least one visual representation (17) for the at least one connection error associated with the threaded connection (15) comprises:
detecting (430) the surface treatment in the at least one visual representation (17);
evaluating (432), in an evaluation, the surface treatment with respect to at least one specification; and
determining (434), in a determination based on the evaluation, an issue with the surface treatment as the at least one connection error; and
wherein providing (450) the result for the threaded connection (15) based on the analysis comprises providing the issue of the threaded connection (15) based on the determination.
7. The method of Clause 6, wherein the surface treatment comprises lubrication applied to thread (12, 14, 22) on at least one of the tubulars (10) before the make-up of the threaded connection (15);
wherein obtaining (410) the at least one visual representation (17) comprises capturing the at least one visual representation (17) associated with the lubrication applied to the thread (12, 14, 22) on at least one of the tubulars (10) before the make-up of the threaded connection (15); and
wherein analyzing (420) the at least one visual representation (17) for the at least one connection error associated with the threaded connection (15) comprises:
detecting (430) the lubrication applied to the thread (12, 14, 22) in the at least one visual representation (17);
evaluating (432), in the evaluation, the lubrication applied to the thread (12, 14, 22) with respect to the at least one specification; and
determining (434), in the determination based on the evaluation, a misapplication of the lubrication to the thread (12, 14, 22) as the at least one connection error; and
wherein providing (450) the result for the threaded connection (15) based on the analysis comprises providing a rejection of the threaded connection (15) based on the determination.
8. The method of Clause 7, further comprising one of:
cleaning the lubrication from the thread (12, 14, 22) in response to the rejection to enable another analysis; and
cleaning the lubrication from the thread (12, 14, 22) in response to the rejection, applying new lubrication to the thread (12, 14, 22), capturing a new visual representation (17) associated with the new lubrication, and analyzing the new visual representation (17) for the at least one connection error.

9. The method of any one of Clauses 1 to 8, wherein initiating (402) the make-up of the threaded connection (15) between the tubulars (10) comprises detecting, with the connection equipment (100), an equipment error in the make-up of the threaded connection (15) by the connection equipment (100); and wherein the method comprises breaking the make-up of the threaded connection (15) in response to the equipment error.
10. The Method of Clause 9,
wherein obtaining (410) the at least one visual representation (17) comprises capturing the at least one visual representation (17) associated with the thread (12, 14, 22) on at least one of end of at least one of the tubulars (10);
wherein analyzing (420) the at least one visual representation (17) for the at least one connection error associated with the threaded connection (15) comprises:
detecting (430) at least one condition of the thread (12, 14, 22) captured in the at least one visual representation (17);
evaluating (432), in an evaluation, the at least one condition of the thread (12, 14, 22) with respect to at least one specification;
determining (434), in a determination based on the evaluation, damage of the thread (12, 14, 22); and
wherein providing the result for the threaded connection (15) based on the analysis comprises providing a rejection of the threaded connection (15) based on the determination.
11. The method of Clause 10, wherein the equipment error includes at least one of over-torquing, under-torquing, and an improper make-up speed in the make-up of the threaded connection (15) by the connection equipment (100); and wherein the damage of the thread (12, 14, 22) includes evidence of at least one of: galling, wear, metal transfer, and cross-threading of the thread (12, 14, 22).
12. The method of any one of Clauses 1 to 11, wherein obtaining (410) the at least one visual representation (17) associated with the make-up of the threaded connection (15) comprises capturing the at least one visual representation (17) using at least one imaging sensor (250, 252, 254) on the rig at a time of the make-up of the threaded connection (15);
wherein obtaining (410) the at least one visual representation (17) associated with the make-up of the threaded connection (15) comprises capturing one or more of: an image with a camera, a terahertz scan with a terahertz scanner, a typographical scan with a tactile probe, and a laser scan with a laser; and
wherein providing (450), with the output interface in the computing environment (60), the result for the threaded connection (15) based on the analysis comprises providing at least one of: a visual alarm (452) to an operator, an audible alarm (452) to the operator, a graphical user interface to the operator, and an automated control to the connection equipment (100) to break the threaded connection (15).
13. The method of any one of Clauses 1 to 12, wherein, in response to the result rejecting the threaded connection (15) for the at least one connection error, the method comprises:
breaking the make-up of the threaded connection (15); and
capturing (410) at least one new visual representation (17) associated with the thread (12, 14, 22) on at least one of end of at least one of the tubulars (10);
detecting (430) at least one condition of the thread (12, 14, 22) captured in the at least one visual representation (17);
evaluating (432), in an evaluation, the at least one condition of the thread (12, 14, 22) with respect to at least one specification;
determining (434), in a determination based on the evaluation, damage of the thread (12, 14, 22); and
providing (450) a rejection of the thread (12, 14, 22) for the at least one tubular based on the determination.
14. The method of any one of Clauses 1 to 13, wherein analyzing (420), in the analysis with the artificial intelligence model (230), the at least one visual representation (17) for the at least one connection error comprises one of:
implementing the artificial intelligence model (230) including a large language model (500) trained (720) by a dataset (350, 710) of training visual representations (17), and analyzing (422) data in the at least one visual representation (17) directly with the large language model (500) for the at least one connection error; implementing the artificial intelligence model (230) including a large language model (500) trained (720) by a dataset (350, 710) of training visual representations (17), converting data in the at least one visual representation (17) input into the large language model (500) into an output of descriptive text, and analyzing (420) the descriptive text with the artificial intelligence model (230) for the at least one connection error; and
implementing the artificial intelligence model (230) including a convolutional neural network (600) trained (720) by a dataset (350, 710) of training visual representations (17), and analyzing (420) data in the at least one visual representation (17) directly with the convolutional neural network for the at least one connection error.
15. A method (300, 400) used in running tubulars (10), the method (300, 400) comprising:
initiating (402) make-up of threaded connection (15)s between the tubulars (10) with connection equipment (100);
capturing (320a, 410), with at least one imaging sensor, visual representations (17) associated with the make-up of the threaded connections (15)s;
receiving (330a), with a control system (50), assessments of initial ones of the threaded connections (15), the assessments being user-indicated and being based on at least one connection error associated with the threaded connections (15);
training (320b, 330b, 720) an artificial intelligence model (230, 722) implemented on the control system (50) with the visual representations (17) based on the assessments;
analyzing (420), in an analysis with the trained artificial intelligence model (230, 730) implemented in a computing environment (60), subsequent ones of the visual representations (17) for the at least one connection error associated with the threaded connections (15); and
providing (450), with the control system (50), outputs indicative of the subsequent threaded connections (15) based on the analysis.
16. The method of Clause 15, further comprising:
receiving (360), with the control system (50), choices of the outputs, the choices being user-indicated and confirming and declining acceptance and rejection of the subsequent threaded connections (15); and
training (330b, 350, 720) the artificial intelligence model (230) implemented on the control system (50) with the captured visual representations (17) based on the choices.
17. A system (50) used in running tubulars (10) on a rig, the system (50) comprising:
at least one imaging sensor (250, 252, 254) being configured to capture at least one visual representation (17) associated with make-up of threaded connections (15) between the tubulars (10);
an output interface (206) configured to provide an output on the rig; and
a computing environment (60) in communication with the at least one imaging sensor (250, 252, 254) and the output interface (206), the computing environment (60) being configured to:
analyze (420), in an analysis with an artificial intelligence model (230) implemented on the computing environment (60), the at least one visual representation (17) for at least one connection error associated with the threaded connection (15); and
provide (450), based on the analysis, a result for the threaded connection (15) in the output of the output interface (206).

The foregoing description of preferred and other embodiments is not intended to limit or restrict the scope or applicability of the inventive concepts conceived of by the Applicants. It will be appreciated with the benefit of the present disclosure that features described above in accordance with any configuration or aspect of the disclosed subject matter can be utilized, either alone or in combination, with any other described feature, in any other configuration or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method used in running tubulars on a rig, the method comprising:
initiating a make-up of a threaded connection between the tubulars using connection equipment on the rig;
obtaining at least one visual representation associated with the threaded connection;
analyzing, in an analysis with an artificial intelligence model implemented in a computing environment, the at least one visual representation for at least one connection error associated with the threaded connection; and
providing, with an output interface in the computing environment, a result for the threaded connection based on the analysis.

2. The method of claim 1, wherein analyzing in the analysis with the artificial intelligence model implemented in the computing environment comprises analyzing with the artificial intelligence model implemented on one or more of: a control system, a remote system, and a cloud-based system in the computing environment in communication with the output interface.

3. The method of claim 1, wherein providing the result for the threaded connection based on the analysis comprises at least one of:
indicating a presence of the at least one connection error;
indicating a rejection of the threaded connection;
indicating an absence of the at least one connection error;
indicating an acceptance of the threaded connection; and
documenting the result of the analysis.

4-5. (canceled)

6. The method of claim 1,
wherein analyzing, in the analysis with the artificial intelligence model, the at least one visual representation for the at least one connection error associated with the threaded connection comprises:
detecting at least one condition associated with the threaded connection captured in the at least one visual representation;
evaluating, in an evaluation, the at least one detected condition with respect to at least one specification; and
determining, in a determination based on the evaluation, that the at least one condition of the threaded connection is indicative of the at least one connection error; and
wherein providing the result for the threaded connection based on the analysis comprises providing a rejection of the threaded connection based on the determination.

7. The method of claim 1,
wherein obtaining the at least one visual representation comprises capturing the at least one visual representation associated with a thread on at least one end of at least one of the tubulars before the make-up of the threaded connection; and
wherein analyzing the at least one visual representation for the at least one connection error associated with the threaded connection comprises:
detecting at least one condition of the thread captured in the at least one visual representation;
evaluating, in an evaluation, the at least one condition of the thread with respect to at least one specification; and
determining, in a determination based on the evaluation, that the at least one condition of the thread is indicative of at least one of: damage of the thread, galling of the thread, wear of the thread, a mismatch thread profile of the thread, debris on the thread, old lubricant left on the thread, insufficient lubrication on the thread, and a deformation of the at least one end as the at least one connection error; and
wherein providing the result for the threaded connection based on the analysis comprises providing a rejection of the threaded connection based on the determination.

8. The method of claim 1,
wherein obtaining the at least one visual representation comprises capturing the at least one visual representation associated with an orientation of the tubulars and threads relative to one another at least one of before, during, and after the make-up of the threaded connection; and
wherein analyzing the at least one visual representation for the at least one connection error associated with the threaded connection comprises:
detecting the orientation captured in the at least one visual representation; and
evaluating, in an evaluation, the orientation with respect to at least one specification;
determining, in a determination based on the evaluation, at least one of a misalignment of the tubulars and a misalignment of the threads as the at least one connection error; and
wherein providing the result for the threaded connection based on the analysis comprises providing a rejection of the threaded connection based on the determination.

9. The method of claim 1,
wherein obtaining the at least one visual representation comprises capturing the at least one visual representation associated with a surface treatment on at least a portion of at least one of the tubulars, the surface treatment; and
wherein analyzing the at least one visual representation for the at least one connection error associated with the threaded connection comprises:
detecting the surface treatment in the at least one visual representation;
evaluating, in an evaluation, the surface treatment with respect to at least one specification; and
determining, in a determination based on the evaluation, an issue with the surface treatment as the at least one connection error; and
wherein providing the result for the threaded connection based on the analysis comprises providing the issue of the threaded connection based on the determination.

10. The method of claim 9, wherein the surface treatment comprises a lubrication applied to a thread on at least one of the tubulars before the make-up of the threaded connection;
wherein obtaining the at least one visual representation comprises capturing the at least one visual representation associated with the lubrication applied to the thread on at least one of the tubulars before the make-up of the threaded connection; and
wherein analyzing the at least one visual representation for the at least one connection error associated with the threaded connection comprises:
detecting the lubrication applied to the thread in the at least one visual representation;
evaluating, in the evaluation, the lubrication applied to the thread with respect to the at least one specification; and
determining, in the determination based on the evaluation, a misapplication of the lubrication to the thread as the at least one connection error; and
wherein providing the result for the threaded connection based on the analysis comprises providing a rejection of the threaded connection based on the determination.

11. The method of claim 10, further comprising one of:
cleaning the lubrication from the thread in response to the rejection to enable another analysis; and
cleaning the lubrication from the thread in response to the rejection, applying new lubrication to the thread, capturing a new visual representation associated with the new lubrication, and analyzing the new visual representation for the at least one connection error.

12. The method of claim 1, wherein initiating the make-up of the threaded connection between the tubulars comprises detecting, with the connection equipment, an equipment error in the make-up of the threaded connection by the connection equipment; and wherein the method comprises breaking the make-up of the threaded connection in response to the equipment error.

13. The method of claim 12,
wherein obtaining the at least one visual representation comprises capturing the at least one visual representation associated with a thread on at least one of end of at least one of the tubulars after breaking the make-up of the threaded connection in response to the equipment error;
wherein analyzing the at least one visual representation for the at least one connection error associated with the threaded connection comprises:
detecting at least one condition of the thread captured in the at least one visual representation;
evaluating, in an evaluation, the at least one condition of the thread with respect to at least one specification;
determining, in a determination based on the evaluation, damage of the thread; and
wherein providing the result for the threaded connection based on the analysis comprises providing a rejection of the threaded connection based on the determination.

14. The method of claim 13, wherein the equipment error includes at least one of over-torquing, under-torquing, and an improper make-up speed in the make-up of the threaded connection by the connection equipment; and wherein the damage of the thread includes evidence of at least one of: galling, wear, metal transfer, and cross-threading of the thread.

15. The method of claim 1, wherein obtaining the at least one visual representation associated with the make-up of the threaded connection comprises capturing the at least one visual representation using at least one imaging sensor on the rig at a time of the make-up of the threaded connection.

16-17. (canceled)

18. The method of claim 1, wherein, in response to the result rejecting the threaded connection for the at least one connection error, the method comprises:
breaking the make-up of the threaded connection; and
capturing at least one new visual representation associated with a thread on at least one of end of at least one of the tubulars;
detecting at least one condition of the thread captured in the at least one visual representation;
evaluating, in an evaluation, the at least one condition of the thread with respect to at least one specification;
determining, in a determination based on the evaluation, damage of the thread; and
providing a rejection of the thread for the at least one tubular based on the determination.

19. The method of claim 1, wherein analyzing, in the analysis with the artificial intelligence model, the at least one visual representation for the at least one connection error comprises:
implementing the artificial intelligence model including a large language model trained by a dataset of training visual representations; and
analyzing data in the at least one visual representation directly with the large language model for the at least one connection error.

20. The method of claim 1, wherein analyzing, in the analysis with the artificial intelligence model, the at least one visual representation for the at least one connection error comprises:
implementing the artificial intelligence model including a large language model trained by a dataset of training visual representations;
converting data in the at least one visual representation input into the large language model into an output of descriptive text; and
analyzing the descriptive text with the artificial intelligence model for the at least one connection error.

21. The method of claim 1, wherein analyzing, in the analysis with the artificial intelligence model, the at least one visual representation for the at least one connection error comprises:
implementing the artificial intelligence model including a convolutional neural network trained by a dataset of training visual representations; and
analyzing data in the at least one visual representation directly with the convolutional neural network for the at least one connection error.

22. A method used in running tubulars, the method comprising:
initiating make-up of threaded connections between the tubulars with connection equipment;
capturing, with at least one imaging sensor, visual representations associated with the make-up of the threaded connections;
receiving, with a control system, assessments of initial ones of the threaded connections, the assessments being user-indicated and being based on at least one connection error associated with the threaded connections;
training an artificial intelligence model implemented on the control system with the visual representations based on the assessments;
analyzing, in an analysis with the trained artificial intelligence model implemented in a computing environment, subsequent ones of the visual representations for the at least one connection error associated with subsequent ones of the threaded connections; and
providing, with the control system, outputs indicative of the subsequent ones of the threaded connections based on the analysis.

23. The method of claim 22, further comprising:
receiving, with the control system, choices of the outputs, the choices being user-indicated and confirming and declining acceptance and rejection of the subsequent ones of the threaded connections; and
training the artificial intelligence model implemented on the control system based on the choices.

24. A system used in running tubulars on a rig, the system comprising:
at least one imaging sensor being configured to capture at least one visual representation associated with make-up of threaded connections between the tubulars;
an output interface configured to provide an output on the rig; and
a control system in communication with the at least one imaging sensor and the output interface, the control system being configured to:
analyze, in an analysis with an artificial intelligence model implemented on the control system, the at least one visual representation for at least one connection error associated with the threaded connection; and
provide, based on the analysis, a result for the threaded connection in the output of the output interface.

25. (canceled)
